(19) United States
(12) Patent Application Publication
(10) Pub. No.: US 2011/0167095 A1
(43) Pub. Date: Jul. 7, 2011

(54) METHOD, APPARATUS AND PROGRAM FOR DATA PROCESSING

(75) Inventor: Tadashi Sato, Tokyo (JP)

(73) Assignee: NEC CORPORATION, TOKYO (JP)

(21) Appl. No.: 13/061,203

(22) PCT Filed: Aug. 25, 2009
(86) PCT No.: PCT/JP2009/064756

§ 371 Date: Feb. 28, 2011

(30) Foreign Application Priority Data
Aug. 26, 2008 (JP) 2008-216278

(51) Int. Cl. G06F 17/30

(52) U.S. Cl. 707/812; 707/E17.005

(57) ABSTRACT

Registration and retrieval of a data set related with a hierarchically-organized identifier and a descendant data set related with an identifier(s) hierarchically lower than the first identifier are improved. Identifier and data are entered pair-wise to a data processing device associated with an identifier. An identifier-related memory stores a record containing an identifier, a data set (group of data related with the identifier), and a descendant data set. The descendant data set is a union of data sets related with the identifier or identifiers hierarchically lower in order than the first identifier. A data registering processor adds received datum to a data set of any of the records stored in the identifier-related data memory if the received identifier is that of the record. The data registering processor also adds received datum to the descendant data set of a record having an identifier hierarchically higher in order than the received identifier.

### TECHNICAL FIELD

The present application claims priority based on JP Patent Application No. 2008-216278 filed in Japan on Aug. 26, 2008. The total disclosures of the patent application of the senior filing date are to be incorporated by reference herein.

This invention relates to an apparatus, a method and a program for processing the data. More particularly, it relates to an apparatus, a method and a program for processing the data in which identifiers of a hierarchical structure and groups of data for the identifiers are managed pair-wise and in which a set of the groups of data is found in keeping with the hierarchical order of the identifier specified.

### BACKGROUND

It may be said that a field of distribution of goods is among the fields in need of a data processing apparatus in which identifiers of a hierarchical structure and groups of data for the identifiers are managed pair-wise and in which a set of the groups of data is found in keeping with the hierarchical order of the identifiers specified.

EPCglobal is an organization whose task is to promote the standardization of systems that exploit RFID (radio tag) for the purpose of improving the efficiency of the distribution of goods with the use of the RFID. These systems cover a range of applications from communication protocols of the RFID tag to interfaces aimed to share the event data that is generated based on e.g., the read-out RFID.

EPCglobal provides for EPCIS (EPC Information Services) as an interface that shares e.g., the data regarding the RFID tags read out by an RFID reader (Non-Patent Document 1).

The unit of the data, dealt with in EPCIS, is termed an EPCIS event. This EPCIS event includes the EPC (Electronic Product Code), which is an identifier of a commercial product, and the time at which the EPC has been read out. The location in which the EPC has been read out may also be included as an option.

The EPCIS has defined BusinessLocationID as a form representing a location. BusinessLocationID may take a hierarchical structure. As values of BusinessLocationID, such values as “maker A”, “warehouse of maker A” and “shelf of the warehouse of maker A” may be defined, only as examples.

In these examples, the “maker A” is a parent of “warehouse of maker A”, and “warehouse of maker A” is a parent of “shelf of the warehouse of maker A”. As regards the hierarchical structure, reference may be made to a paragraph 6.5 of Non-Patent Document 1. In the following, the values of BusinessLocationID are stated as bizLocation.

Another related technique is Patent Document 1. This Patent Document 1 has disclosed a method in which, in case a particular object belonging to a set of objects of the hierarchical structure has been specified, descendant objects towards the leaf side of such particular object are recursively referenced to find the total of the objects towards the leaf side of the particular object.

It is now envisaged to find an address of an EPCIS server, holding an EPCIS event, from the bizLocation. Such address may be found by applying the method disclosed in Patent Document 1, for example. Initially, the bizLocation and an object are correlated with each other in a one-for-one relationship. In addition, a group of EPC server addresses is correlated with the respective objects. These EPC server addresses hold EPCIS events stating the bizLocation correlated with the objects. In case a certain bizLocation has been specified, a group of the EPCIS server addresses, correlated with respective objects towards the leaf side of the object correlated with the bizLocation are found, and a union of the EPCIS servers of the group as found is then obtained in order to find the group of the EPCIS server addresses correlated with the bizLocation.

### [Patent Document 1]

JP Patent Kokai Publication No. JP-P2007-219621A

### [Non-Patent Document 1]

http://www.epcglobalinc.org/standards/epcis/epcis_{—}1_{—}0_{—}1-standard-200 70921.pdf (as of Apr. 21, 2008)

### SUMMARY

The total contents of disclosures of the above mentioned Patent Document 1 and Non-Patent Document 1 are to be incorporated by reference herein.

The following is an analysis by the present invention.
In the above mentioned EPCIS server, for example, EPCIS events, produced in succession with lapse of time, are stored. In keeping pace therewith, the relationship of correspondence between the bizLocation and the addresses of the EPCIS servers, associated therewith, need to be updated dynamically.

However, in the above mentioned Patent Document 1, there lacks the description concerning the dynamic update of objects. It is thus not possible with the Patent Document 1 to cope with such dynamic update of the relationship of correspondence between the bizLocation and the EPCIS server addresses. In addition, with the method disclosed in the above mentioned Patent Document 1, each time a particular object has been specified, the objects towards the leaf side of such particular object are referenced in order to find the objects towards the leaf side of such particular object. It is thus necessary to retrieve a number of the objects equal to the number of objects that form a sub-tree having the specified object as a root at the maximum. Hence, the technique of Patent Document 1 takes much processing time, and is therefore inefficient, when applied to the retrieval of the EPCIS server addresses that specify the bizLocation.

In view of the above described status of the art, it is an object of the present invention to provide an arrangement for efficient registration and retrieval of a set of data related with a received identifier and a set of its descendant data. Such registration and retrieval may be exemplified by registering and retrieving, from the bizLocation, the EPCIC servers in which there are stored EPCIS events.

Thus, there is much to be desired in the art.

In a first aspect of the present invention, there is provided a data processing device comprising an identifier-related data memory and a data registering processor. The identifier-related data memory stores a plurality of records each of which contains a hierarchically-organized identifier, a set of data each of which is related with the identifier, and a set of descendant data that is a union of sets of data related with each of all hierarchically-lower identifiers than the identifier and a data registering processor. The data registering processor receives the identifier and the datum. The data registering processor adding the received datum to the set of data of the record with the received identifier if the received identifier is the identifier of any of the records stored in the identifier-related data memory; The data registering processor, otherwise, adding the received datum to the set of descendant data of the record with the hierarchically-upper identifier than the received identifier.

In a second aspect of the present invention, there is provided a data processing method in which each of a plurality of data processing devices holds a plurality of records each containing a hierarchically-organized identifier, a set of data and a set of descendant data. The set of data each of which is related with the identifiers, and the set of descendant data which set is a union of sets of data related with each of all hierarchically-lower identifiers than the identifier. The data processing device related with the identifier in accordance with a predetermined rule adds received datum to a set of data of the record with the received identifier. In case the received identifier does not match with the identifiers of any of the records stored, the data processing device adds the received datum to a descendant data set of the record with a hierarchically upper identifier than the received identifier. Each data processing device related with the received identifier updates the record. On receipt of a data inquiry by the identifier, each data processing device related with the received identifier outputs data of the record having an identifier matches to the received identifier.

In a third aspect of the present invention, there is provided a data processing system in which the above mentioned data processing devices are hierarchically arranged and in which data registering processing or data retrieving processing is invoked from an upper order or root side towards a lower side or leaf side until the record of interest is found.

In a fourth aspect of the present invention, there is provided a data processing system including a directory server that specifies a data processing device holding a record of interest. The data registering processing is invoked from the data processing device in a direction towards an upper order side.

According to the present invention, registering and retrieval of a set of data correlated with a received identifier and a set of its descendant data may be improved in efficiency. The reason is that not the total of the data processing devices that make up a tree are accessed but the data processing device identified by a hierarchically-organized identifier performs the registering and retrieving operations.

### BRIEF DESCRIPTION OF THE DRAWINGS

FIG. 1 is a schematic view showing an example formulation of an exemplary embodiment 1 of the present invention.

FIG. 2 is a block diagram showing a formulation of a retrieval device that goes to make up a retrieval system according to the exemplary embodiment 1 of the present invention.

FIG. 3 is a diagram showing the example data stored in a location data memory of the retrieval device of FIG. 2.

FIG. 4 is a diagram showing the example data stored in the location data memory of a root retrieval device of FIG. 2.

FIG. 5 is a diagram showing example data stored in a descendant device memory of an optional retrieval device of FIG. 2.

FIG. 6 shows example data stored in a child retrieval device memory of a parent retrieval device of a retrieval device that stores data.

FIG. 7 shows the flow of processing carried out in a location data registering processor of a retrieval device that constitutes a retrieval system of the exemplary embodiment 1 of the present invention.

FIG. 8 is a flowchart showing the flow of processing carried out in a location data retrieving processor that constitutes a retrieval system of the exemplary embodiment 1 of the present invention.

FIG. 9 is a schematic view showing an example formulation of an exemplary embodiment 2 of the present invention.

FIG. 10 is a schematic view for illustrating the relationship among the retrieval devices of the exemplary embodiment 2 of the present invention.

FIG. 11 is a block diagram showing the formulation of a retrieval controller included in the retrieval system of the exemplary embodiment 2 of the present invention.

FIG. 12 is a flowchart showing the flow of processing carried out in a location data registering processor of a retrieval controller included in the retrieval system of the exemplary embodiment 2 of the present invention.

FIG. 13 is a flowchart showing the flow of processing carried out in a location data retrieving processor of the retrieval controller included in the retrieval system of the exemplary embodiment 2 of the present invention.

FIG. 14 is a block diagram showing the formulation of a retrieval device included in the retrieval system of the exemplary embodiment 2 of the present invention.

FIG. 15 is a flowchart showing the flow of processing carried out by a location data registering processor of the retrieval device included in the retrieval system of the exemplary embodiment 2 of the present invention.

FIG. 16 is a flowchart showing the flow of processing carried out by a location data retrieving processor of the retrieval device included in the retrieval system of the exemplary embodiment 2 of the present invention.

FIG. 17 is a block diagram showing the formulation of a directory server included in the retrieving system of the exemplary embodiment 2 of the present invention.

FIG. 18 is a diagram showing the example data stored in a directory data memory of the directory server of FIG. 17.

FIG. 19 is a flowchart showing the flow of processing carried out in a retrieval processor of a retrieval device of a directory server included in the retrieving system of the exemplary embodiment 2 of the present invention.

FIG. 20 is a schematic view showing an example formulation of an exemplary embodiment 3 of the present invention.

FIG. 21 is a block diagram showing the formulation of a retrieval device included in the retrieval system according to the exemplary embodiment 3 of the present invention.

FIG. 22 is a diagram showing the example data stored in a location data memory of a retrieval device according to the present invention.

FIG. 23 is a flowchart showing the flow of processing carried out in a location data registering processor of the retrieval device according to the exemplary embodiment 3 of the present invention.

FIG. 24 is a flowchart showing the flow of processing carried out in a location data retrieving processor of the retrieval device included in the retrieval system according to the exemplary embodiment 3 of the present invention.

FIG. 25 is a flowchart showing the flow of processing carried out in the location data update processor of the retrieval device according to the exemplary embodiment 3 of the present invention.

FIG. 26 is a flowchart showing the flow of processing carried out in the location data update processor of a child retrieval device included in the retrieval system according to the exemplary embodiment 3 of the present invention.

FIG. 27 is a flowchart showing the flow of processing of response message generation carried out in a processor for response message generation of the retrieval system according to the exemplary embodiment 3 of the present invention.

FIG. 28 is a schematic view showing an example formulation of an exemplary embodiment 4 of the present invention.

FIG. 29 is a block diagram showing the formulation of a retrieval device included in a retrieval system of the exemplary embodiment 4 of the present invention.

FIG. 30 is a diagram showing example data made up of location IDs and addresses of the information providing devices.

FIG. 31 is a flowchart showing the flow of processing carried out by a location data registering processor of a retrieval system of the exemplary embodiment 4 of the present invention.

FIG. 32 is a flowchart showing the flow of processing carried out by a child retrieval device location data registering processor of the retrieval system of the exemplary embodiment 4 of the present invention.

FIG. 33 is a flowchart showing the flow of processing carried out by a processor for response message generation of the retrieval system of the exemplary embodiment 4 of the present invention.

FIG. 34 is a block diagram showing a sub-set of the retrieval device of the present invention.

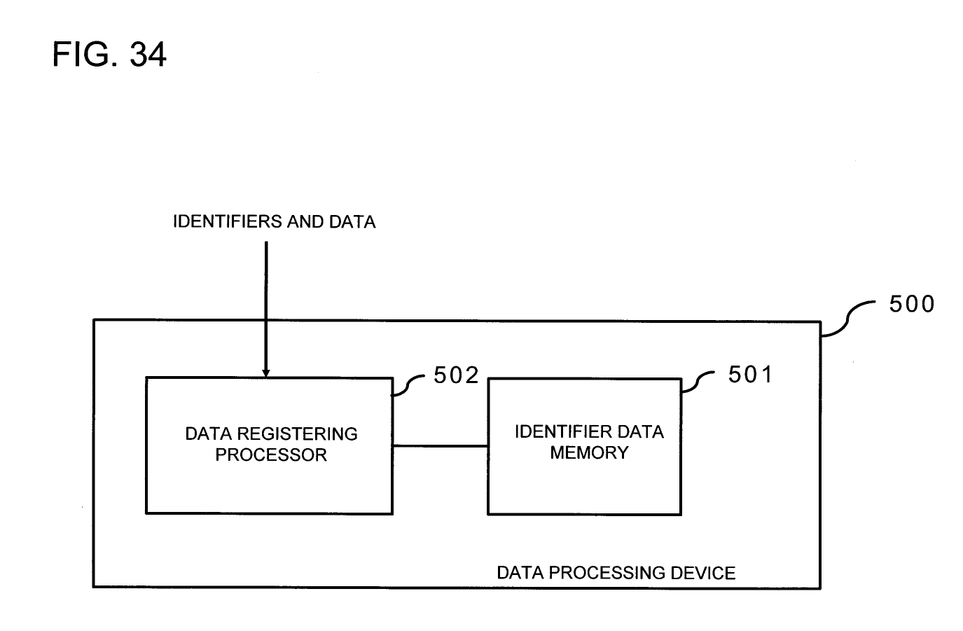

### PREFERRED MODES

Preferred exemplary embodiments of the present invention will now be described in detail with reference to the drawings. In the following, a device that provides the data, such as EPCIS server, is referred to as an ‘information providing device’, and one or more of identifiers (IDs), hierarchically representing a location, such as bizLocation, is referred to as a ‘location ID’. A unit of data, including the location ID, such as EPCIS event, is referred to as ‘event’.

In the exemplary embodiments that follow, a location ID and an address of the information providing device are managed pair-wise. It is noted that the identifier may not be the location ID and may also be an identifier of a hierarchical structure, and the address of the information providing device may also be data at large.

### Exemplary Embodiment 1

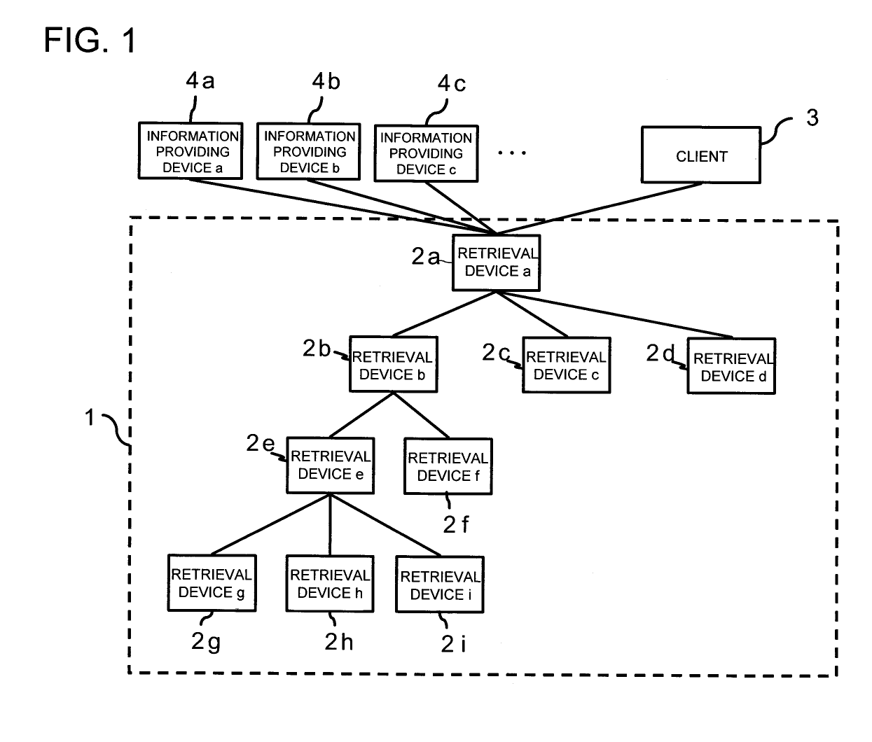

Initially, an exemplary embodiment 1 will be described with reference to the drawings. FIG. 1 shows an example formulation of the exemplary embodiment 1 of the present invention. Referring to FIG. 1, there are shown a retrieval system 1, information providing devices 4a to 4c, and a client 3. When the data held by the information providing devices 4a to 4c is updated, such effect is notified by these devices 4a to 4c to the retrieval system 1. The client 3 may request the retrieval system 1 to perform retrieval. The client 3, retrieval system 1 and the information providing devices 4a to 4c are interconnected over a network, such as the Internet. In FIG. 1, solid lines interconnecting any two of the components indicate that the components in question may have communication with each other over the network.

Although FIG. 1 shows only one client and three information providing devices 4a to 4c, there may also be any suitable optional numbers of the client and the information providing devices.

The retrieval system 1 is composed of a plurality of retrieval devices 2a to 2i that are of a hierarchically arrayed structure, either physically or logically, as shown for example in FIG. 1. In the present and following exemplary embodiments, the retrieval devices are equivalent to the data processing devices of the above described related art. The retrieval system 1 includes the function of updating data held by the retrieval devices 2 of the retrieval system 1 in response to a data update notification from the information providing devices 4a to 4c. The retrieval system also includes the function of providing the addresses of the information providing devices 4a to 4c corresponding to the location IDs as specified by the client 3.

The retrieval device 2a at the upper most position in the hierarchical structure, out of the retrieval devices 2a to 2i that make up the retrieval system 1, is termed a ‘root retrieval device’. The lower retrieval devices 2c, 2d, 2e, 2f, 2g, 2h and 2i are termed ‘leaf retrieval devices’. Out of any two of the interconnected retrieval devices, the retrieval device closer to the root retrieval device is termed a ‘parent retrieval device’ for the counterpart retrieval device, while the other retrieval device, remoter from the root retrieval device, is termed a ‘child retrieval device’ for the counterpart retrieval device. The retrieval device(s) lower in the hierarchical structure than a given one of the retrieval devices are termed ‘descendant retrieval device(s) for the given retrieval device. The retrieval device(s) upper in the hierarchical structure than a given one of the retrieval devices are termed ‘ancestor retrieval device(s) for the given retrieval device.

For example, the retrieval device 2a is a parent retrieval device as well as an ancestor device for the retrieval device 2b. The retrieval device 2b is a child retrieval device as well as a descendant device for the retrieval device 2a. The retrieval devices 2b to 2i are descendant retrieval devices for the retrieval device 2a.

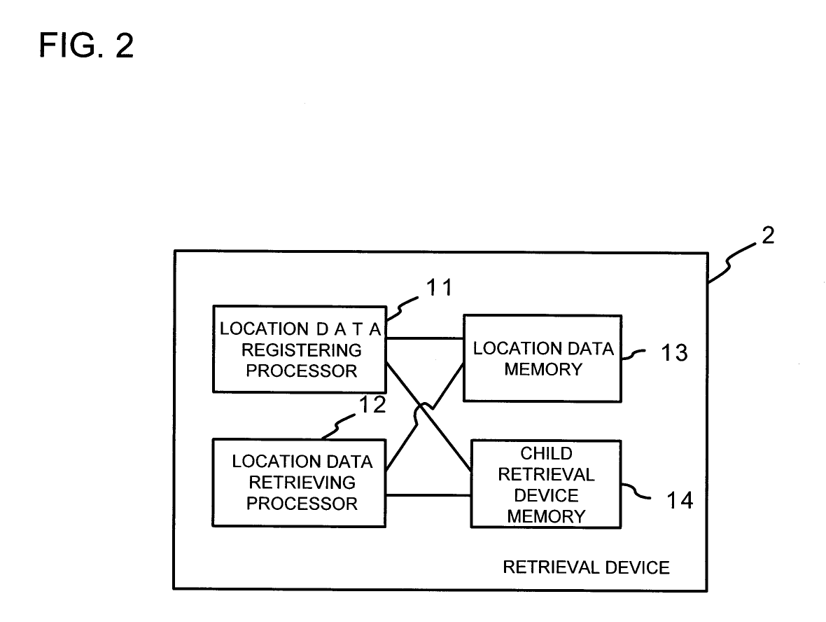

FIG. 2 shows the formulation of the retrieval device 2 that may be used as any of the retrieval devices 2a to 2i. The retrieval device 2 includes a location data registering processor 11, a location data retrieving processor 12, a location data memory 13 and a child retrieval device memory 14. In the present and following exemplary embodiments, the location data registering processor, location data retrieving processor, location data memory and the child retrieval device memory are equivalent to the above mentioned data registering processor, data retrieving processor and identifier-related data memory and to a child data processor memory which appears in the claim. These retrieval devices may be constructed by optional data processors.

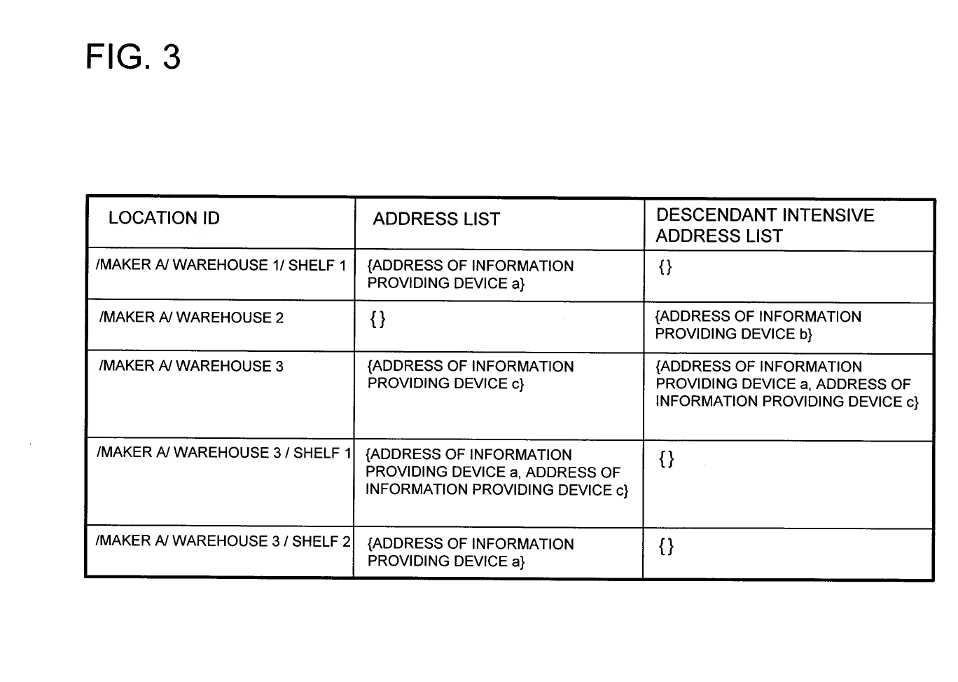

FIG. 3 shows the example data stored in the location data memory 13. The location data memory 13 stores a plurality of records each of which is composed of data in turn composed of a location ID, an address list and a descendant intensive address list.

The location ID is one or more of hierarchically-organized identifiers. Here, the hierarchical structure of the location ID is expressed by separation using slashes (/). For example, “/maker A/warehouse 2” shown in FIG. 3 is a location ID representing a warehouse 2 owned by the maker A.

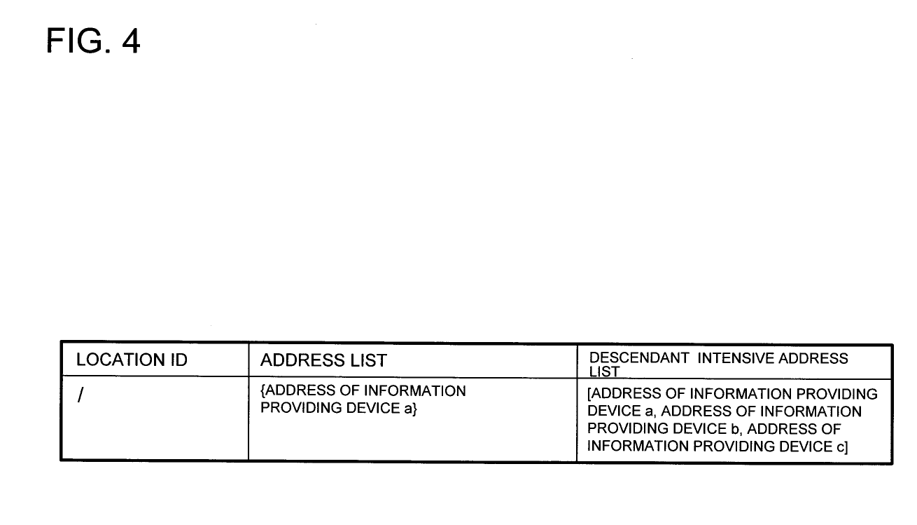

The location ID at the upper most position in the hierarchical structure is termed a root location ID, and is labeled “/”. If the data specifying the location is not contained in an event, the location ID of such event is held to be a root location ID. The root location ID is stored in the location data memory 13 of the root retrieval device 2a. FIG. 4 shows the example data stored in the location data memory 13 of the root retrieval device 2a.

The location ID hierarchically one level below the location ID “x” is termed a ‘child ID’ of the location ID “x”. The location IDs hierarchically below the location ID “x” are termed ‘descendant location IDs’ of the location ID “x”. The location ID hierarchically one level above the location ID “x” is termed a ‘parent ID’ of the location ID “x”. The location IDs hierarchically above the location ID “x” are termed ‘ancestor location IDs’ of the location ID “x”.

For example, “/maker A/warehouse 3” is a child ID as well as a descendant ID of the “/maker A”, and “/maker A/warehouse 3/shelf 1” is a descendant location ID of “/maker A”. On the other hand, “/maker A” is a parent location ID, while also being an ancestor location ID for “/maker A/warehouse 3”. Also, “/maker A” is an ancestor location ID for “/maker A/warehouse 3/shelf 1”.

The location IDs of respective records, stored in the location data memory 13 of the retrieval device 2, are termed ‘management location IDs’ of the retrieval device. When the retrieval device holds a management location ID “x”, one may say: the retrieval device is managing the location ID “x”, in order to express such state. The management location IDs of the retrieval devices that store the data shown in FIG. 3 are: “/maker A/warehouse 1/shelf 1”, “/maker A/warehouse 2”, “/maker A/warehouse 3”, “/maker A/warehouse 3/shelf 1” and “/maker A/warehouse 3/shelf 2”.

The address list of the record stored in the location data memory 13 is a list of the addresses of the information providing devices 4a to 4c. The addresses contained in the address list of the record are the addresses of the information providing devices 4a to 4c each holding the event that states the location ID of the record.

The descendant intensive address list of the record stored in the location data memory 13 is a list of addresses of the information providing devices 4a to 4c. The addresses contained in the descendant intensive address list of the above record are addresses of the information providing devices 4a to 4c holding the events that state the descendant location IDs of the location ID of the record.

According to the present invention, it is postulated that the retrieval device 2 consigns one or more location IDs to its descendant devices. ‘Consigning’ herein means ‘having a location ID managed’ by e.g., descendant retrieval devices. The retrieval device, to which the location ID has been consigned, manages the location ID or consigns the location ID to its descendant retrieval device(s). In short, the hierarchically lower order location IDs are managed by hierarchically lower order retrieval devices.

According to the present invention, it is further postulated that the following two presuppositions are valid in connection with the location IDs managed by the retrieval device 2.

First, the retrieval devices 2 need to be consigned in units of sub-trees of a location ID tree. For example, in consigning the location ID “/maker A/warehouse 1”, its descendant location ID “/maker A/warehouse 1/shelf 1” also needs to be consigned.

Second, a given location ID is necessarily managed by a sole retrieval device. Viz., there should be no overlapping of a location ID of one sub-tree being consigned with a location ID of another sub-tree being consigned.

In the child retrieval device memory 14 of a given retrieval device, there are stored a plurality of records each of which is composed of a location ID that has been consigned by the retrieval device and an address of the child retrieval device managing the location ID. The location ID, stored in the child retrieval device memory 14, is the location ID corresponding to the root of a sub-tree of the consigned location ID.

From the above presuppositions, it may be said that the following relationships hold in connection with the location IDs stored in the location data memories 13 and the child retrieval device memories 14 of the retrieval device “x” and a child retrieval device “y” of the retrieval device “x”:

A group of location IDs of records having a retrieval device address “y”, out of groups of location IDs stored in the child retrieval device memory 14 of the retrieval device “x”, and a group of the descendant location IDs thereof, combined together, is set as a set S. A group of the location IDs stored in the location data memory 13 of the retrieval device “y” is set as a set A. A set of descendant location IDs of the location IDs of an i'th record, stored in the child retrieval device memory 14 of the retrieval device “y”, is summed to the location ID of the i'th record, and the resulting sum is set as C[i], where i is a number from 1 to the number of the records. The union of the total of C[i] is set as C. In this case, S=A∪C, A∩C=φ, C(i)∩C[j]=φ (∀i, j, i≠1) hold, where φ denotes an empty set.

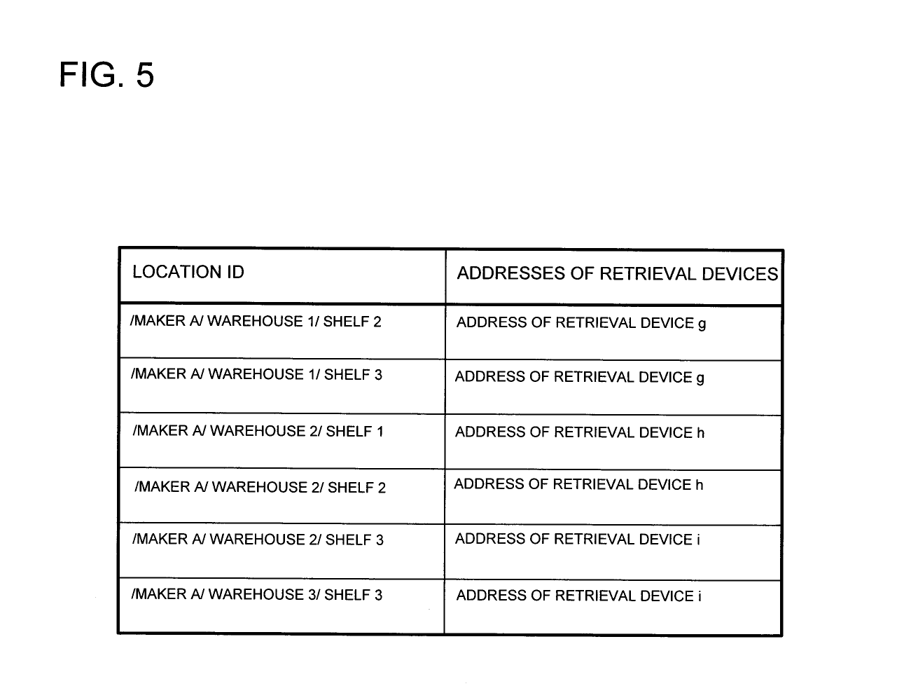

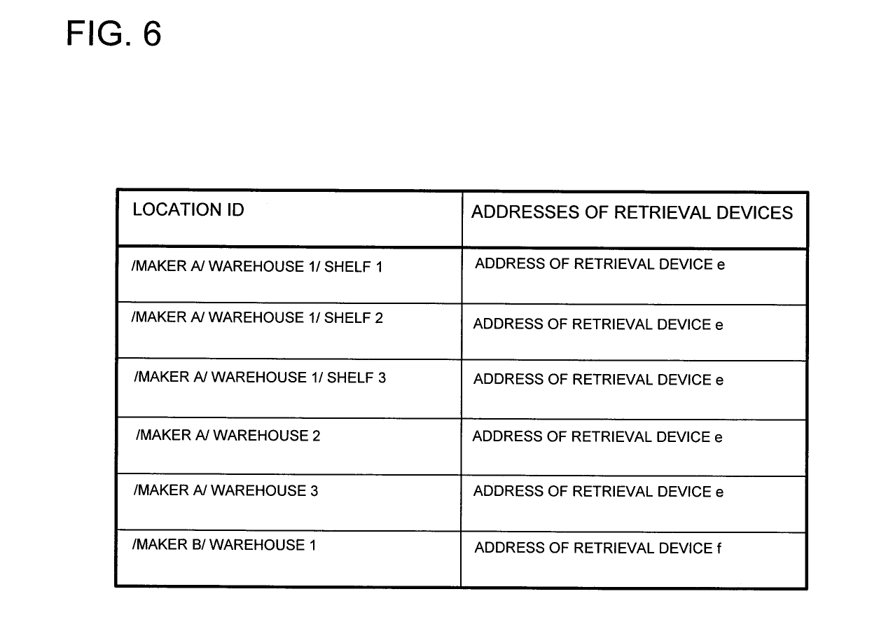

FIG. 5 shows example data stored in the child retrieval device memory 14 of a retrieval device, such as, for example, the retrieval device 2e of FIG. 1, in case data shown in FIG. 3 is stored in the location data memory 13 of the retrieval device (retrieval device 2e). FIG. 6 shows example data stored in the child retrieval device memory 14 of the parent retrieval device of the retrieval device (retrieval device 2e). The parent retrieval device is the retrieval device 2b of FIG. 1, for example.

In setting data stored in the child retrieval device memory 14, such setting means as stating the data in a setting file of each retrieval device 2 may be used.

The location data registering processor 11 of the retrieval device updates the data stored in the location data memory 13, based on a received location ID and on a received address of the information providing device. In case the received location ID is not the management location ID of the retrieval device, the location data registering processor executes the location data registering processing on the child retrieval device as determined by the received location ID.

By recursively carrying out the processing of registering the location data, beginning from the root retrieval device 2a, the location data of the retrieval system is updated in its entirety to assure integrity of the retrieval system.

The location data retrieving processor 12 of a retrieval device returns an address of the information providing device, corresponding to the received location ID, stored in the location data memory 13, in case the received location ID is the management location ID of the retrieval device. Otherwise, the location data retrieving processor requests the child retrieval device, as determined by the received location ID, to perform the location data retrieving processing.

By recursively carrying out location data retrieval processing, beginning from the root retrieval device, it is possible to get to the retrieval device 2 that manages the received location ID, thereby finding the address of the information providing device.

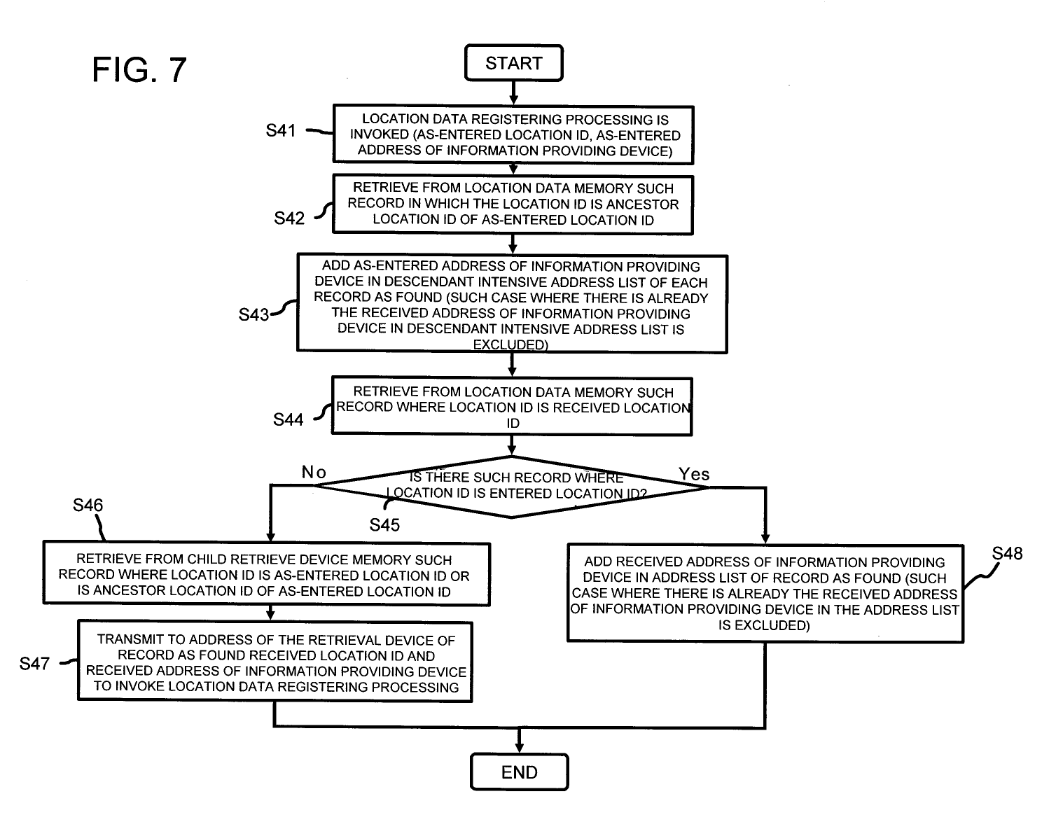

The processing for registration, recursively carried out by each retrieval device 2, will now be described. FIG. 7 shows the flow of processing carried out by the location data registering processor 11.

When a retrieval device 2 has received an address of an information providing device that holds a location ID and an event that states the location ID, the location data registering processing by the location data registering processor 11 is invoked (step S41). The location ID and the address of the information providing device, as received, are termed the ‘received location ID’ and the ‘received address of the information providing device’, respectively.

The location data registering processor 11 then retrieves, from the location data memory 13, such a record in which the location ID is an ancestor location ID of the received location ID (step S42) and adds the received address of the information providing device to the descendant intensive address list of each record as found (step S43). The received address of the information providing device is not so added in case the received address of the information providing device has already been contained in the descendant intensive address list.

Among the methods for determining whether or not the location ID is an ancestor location ID of the received location ID, there is a method of determining the forward coincidence of the location IDs. In case of forward coincidence of a location ID with the received location ID, such location ID is an ancestor location ID of the received location ID. The location ID “x” being forwardly equal to the location ID “y” indicates that, in case location IDs “z” existing from the location ID “y” to the depth of the location ID “x” have been extracted, the location ID “x” coincides with the location IDs “z”. For example, if the location ID “x” is “/maker A/warehouse 1’ and the location ID “y” is “/maker A/warehouse 1/shelf 1”, the location ID “z” is “/maker A/warehouse 1′, with the location ID “x” forwardly coinciding with the location ID “y”.

The location data registering processor 11 then retrieves, from the location data memory 13, a record in which the location ID is the received location ID (step S44).

If, as a result of the above mentioned retrieval, there exists no record that matches such condition of location ID coincidence (NO of step S45), the location data registering processor 11 retrieves, from the child retrieval device memory 14, such a record in which the location ID is the received location ID or is an ancestor location ID of the received location ID (step S46). The location data registering processor 11 transmits the received location ID and the received address of the information providing device to the address of the retrieval device of the record thus found, and invokes the location data registering processing (step S47). This completes the location data registering processing at the source of invocation.

If, as a result of the above mentioned retrieval, there exists the record that matches the above condition (YES of step S45), the location data registering processor 11 adds the received address of the information providing device to an address list of the record as found (step S48) to complete the location data registering processing. If the received address of the information providing device has already been contained in the address list, such addition is not made.

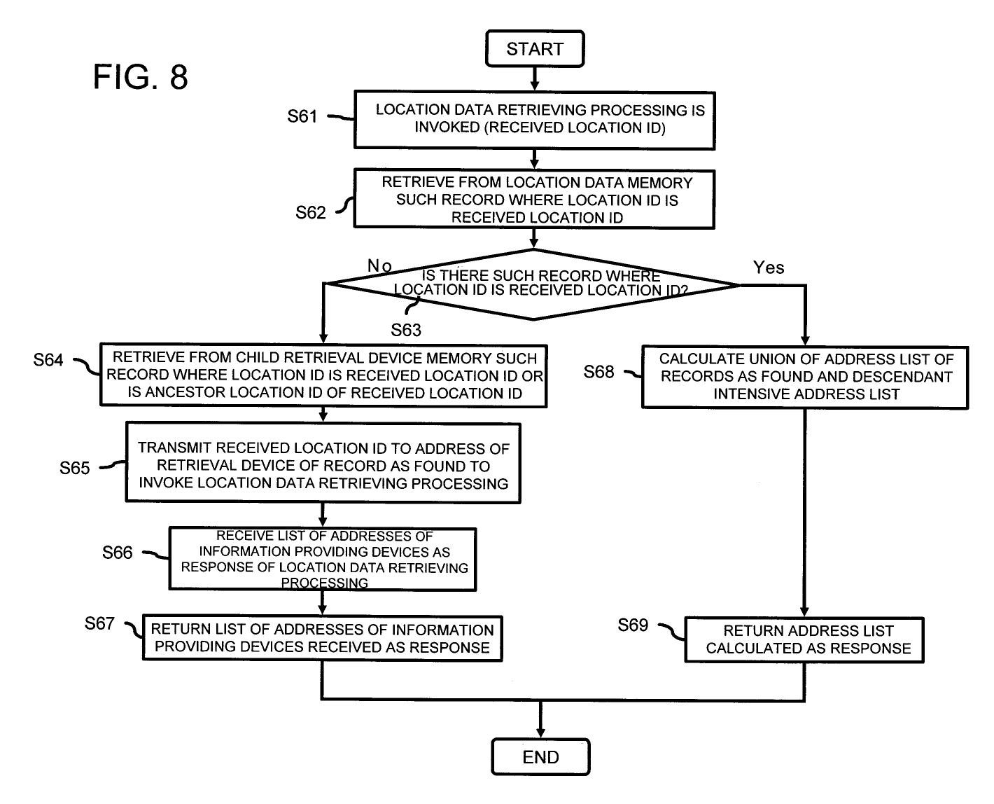

The retrieving processing, recursively performed by each retrieval device 2, will now be described. FIG. 8 shows the flow of processing carried out by the location data retrieving processor 12.

When a retrieval device 2 has received an inquiry into the address of the information providing device, specifying the location ID, the location data retrieving processing by the location data retrieving processor 12 is invoked (step S61). The location ID received is termed a ‘received location ID’.

Subsequent processing from step S62 until step S64 is the same as the processing from step S44 until step S46 shown in FIG. 7.

If, as a result of retrieval of the location data memory 13 as to the location ID coinciding with the received location ID, there is no record that matches the condition, viz., the condition of coincidence of the location IDs, the location data retrieving processor 12 retrieves, from the child retrieval device memory 14, such a record in which the location ID is the received location ID or is an ancestor location ID of the received location ID (step S64). The location data retrieving processor 12 transmits the received location ID to an address of the retrieval device of the record as found to invoke the location data retrieving processing (step S65). As a response, the location data retrieving processor 12 receives an address list of the information providing devices (step S66). The location data retrieving processor 12 returns the information providing device address list to the source of invocation (step S67) as a response to terminate the location data retrieving processing.

If, as a result of retrieving the location data memory 13 for the location ID coinciding with the received location ID, there is a record that matches the above mentioned condition, viz., a record with the location ID coincidence (YES of the step S63), the location data retrieving processor 12 calculates a union of the address list of the record as found and the descendant intensive address list (step S68). The location data retrieving processor returns the result as a response to the source of invocation (step S69).

With the above described exemplary embodiment 1 of the present invention, it is possible to cope with increase in the update or reference frequency of the data retained by the retrieval system, or increase in the volume of the data retained by the system. For example, the exemplary embodiment 1 may be used to advantage in e.g., a retrieval system that will resolve the EPCIS server addresses from bizLocation. The reason is that distributed processing may be carried out by a plurality of hierarchically arranged retrieval devices.

Among principal factors that will influence the retrieval time in carrying out data retrieval by a plurality of retrieval devices, there is such a factor as how many retrieval devices have been run to carry out a retrieving operation. In the present exemplary embodiment, the number of the retrieval devices, performing the registering processing at the time of data registration, is equal to the depth of the location ID entered in registering the data. The same applies for a case where the retrieval device has no descendant address list and only the address list is updated.

When the datum is registered in an information system or the datum is retrieved in the retrieval system, the time taken in such processing is influenced by how many of the retrieval devices that make up the retrieval system have been in operation to execute the processing. In data retrieval, with the use of the method of Patent Document 1, it is necessary to access the total of the retrieval devices that form a tree having the retrieval device managing the location ID as a root. In the present exemplary embodiment, the processing for retrieval may be accomplished by accessing the retrieval devices located on a path from the root retrieval device to the retrieval device that manages the received location ID.

Moreover, if the method of Patent Document 1 is used in the data retrieval, it is necessary to access the total of the retrieval devices that form a tree whose root is the retrieval device managing the location ID. In the retrieval device of the present exemplary embodiment, the retrieving processing may be accomplished by a number of times of accessing operations equal at most to the depth of the received location ID. That is, the cost of data retrieval may be reduced without increasing the cost of data registration.

That is, in the present exemplary embodiment, the number of the retrieval devices that execute the registering processing in data registration is similar to that in data retrieval. Viz., the registering processing may be accomplished by accessing the retrieval devices on the path from the root retrieval device down to the retrieval device managing the received location ID. The number of times of accessing is the same as that in updating only the address list without the retrieval device having the descendant address list. Viz., according to the present invention, the cost in data retrieval may be decreased without increasing the cost in registering the data.

### Exemplary Embodiment 2

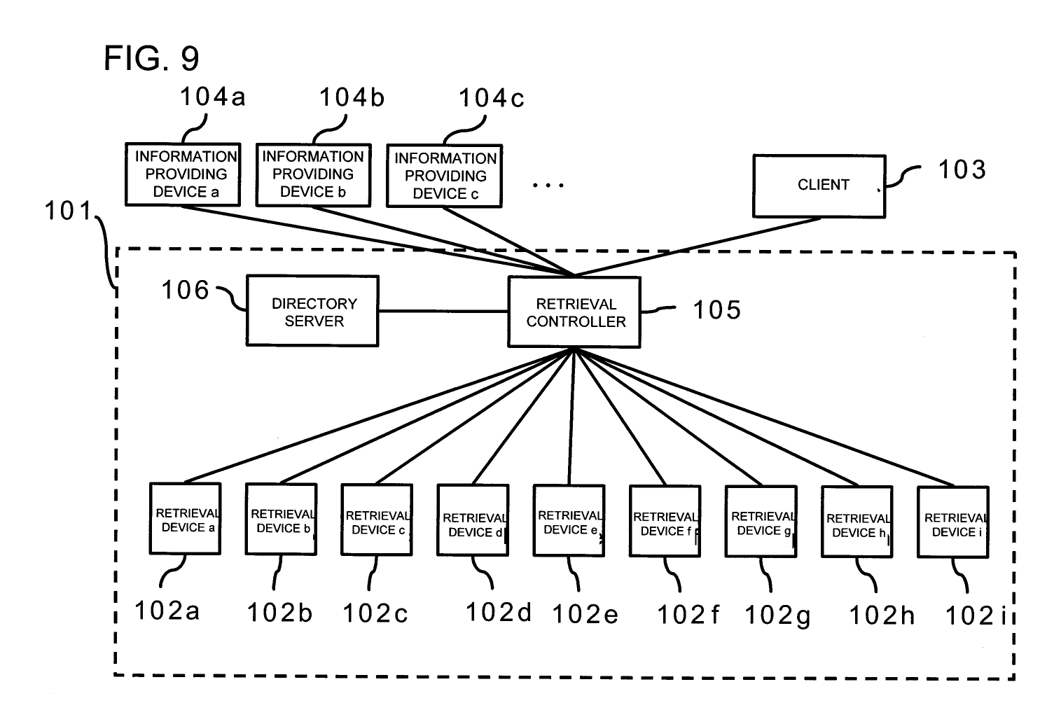

An exemplary embodiment 2, in which the number of the retrieval devices invoked in the processing of registering the location data may be reduced in comparison with the above described exemplary embodiment 1, will now be described with reference to the drawings. FIG. 9 shows a block diagram illustrating an example configuration of the exemplary embodiment 2 of the present invention.

Referring to FIG. 9, there are shown a retrieval system 101, information providing devices 104a to 104c and a client 103. A directory server 106 and a retrieval controller 105 are newly provided in the retrieval system. When the information providing devices 104a to 104c update the data, the information providing devices 104a to 104c indicate such effect to the retrieval system 101. The client requests the retrieval system 101 to perform retrieval.

Referring to FIG. 9, the retrieval system 101 includes retrieval devices 102a to 102i, in addition to the retrieval controller 105 and the directory server 106 referred to above. The retrieval devices each provide an address of the information providing device associated with the location ID. The retrieval controller 105 controls the directory server 106 and the retrieval devices 102a to 102i to update or retrieve the location data. The directory server 106 manages the location IDs and the retrieval devices managing the location IDs pair-wise. The retrieval system 101 of the present exemplary embodiment has the function of correcting an event in response to a data update notification from the information providing devices 104a to 104i, and a function of providing addresses of the information providing devices 104a to 104c associated with the location IDs specified by the client 103.

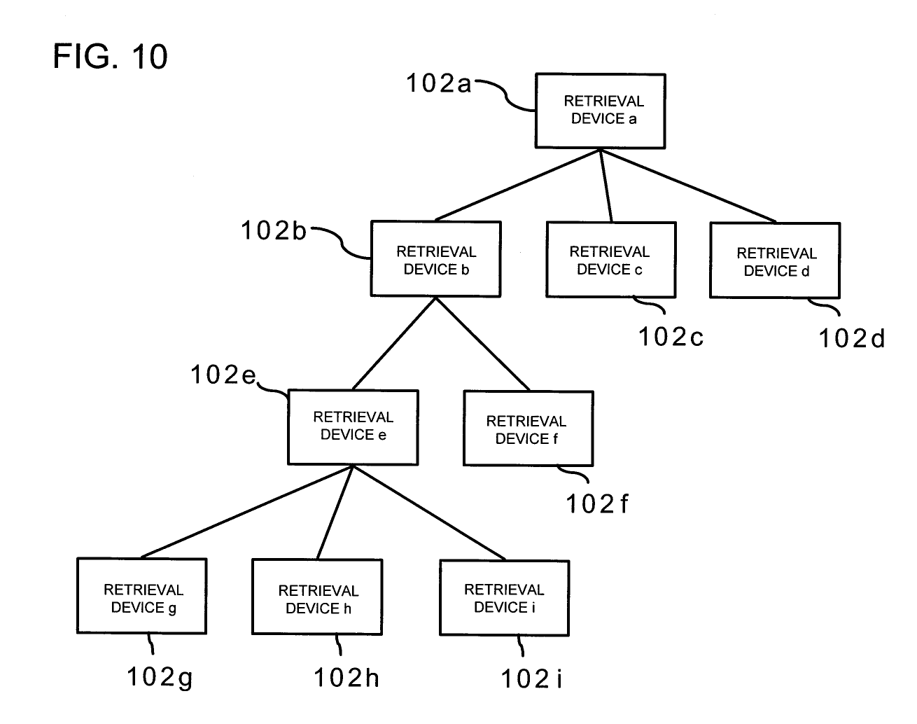

FIG. 10 shows the relationship among the retrieval devices which is based on the hierarchical structure of the location IDs managed by the retrieval devices 102a to 102i (management location IDs). It is seen from FIG. 10 that there is established a hierarchical structure similar to that of the retrieval devices of the retrieval system of the exemplary embodiment 1 (see FIG. 2).

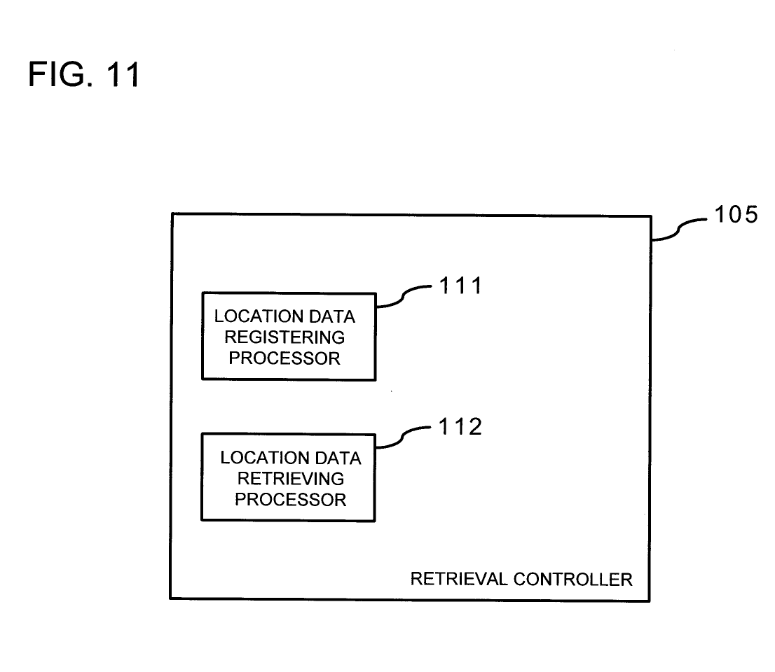

FIG. 11 shows a formulation of the retrieval controller 105 including a location data registering processor 111 and a location data retrieving processor 112. It should be noted that the location data registering processor 111 and the location data retrieving processor 112 operate as a data registering processor and hence the retrieval controller 105 is equivalent to the data processing controller.

Based on the received location ID, the location data registering processor 111 resolves an address of the retrieval device which is to carry out the location data registering processing (one of the retrieval devices 102a to 102i) by the directory server 106. The location data registering processor 111 performs the processing of registering the location data on the retrieval device thus resolved (one of the retrieval devices 102a to 102i).

When the location data retrieving processing is invoked, the location data retrieving processor 112 resolves, by the directory server 106, the address of the retrieval device (one of the retrieval devices 102a to 102i) by means of which the processing of retrieving the location data is to be executed. The location data retrieving processor 112 executes the processing of retrieving the location data on the so resolved retrieval device (one of the retrieval devices 102a to 102i).

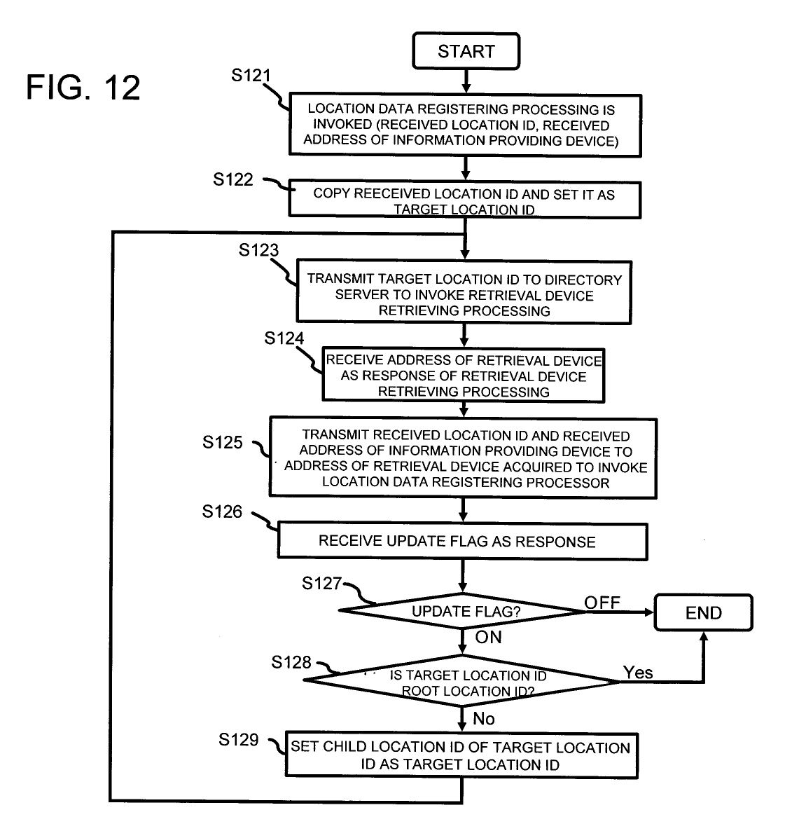

FIG. 12 shows the flow of processing carried out in the location data registering processor 111. When the retrieval controller 105 has received an address of the information providing device that holds the location ID and an event that states the location ID, the location data registering processing by the location data registering processor 111 is invoked (step S121). The location ID and the address of the information providing device received are termed a ‘received location ID’ and ‘a received address of an information providing device’, respectively.

Initially, the location data registering processor 111 generates a copy of the received location ID and sets it as a target location ID (step S122).

The location data registering processor 111 then transmits the received location ID to the directory server 106 and invokes the retrieval device retrieving processing (step S123). The location data registering processor receives the address of the retrieval device as response (step S124).

The location data registering processor 111 then transmits the received location ID and the received address of the information providing device to the received address of the information providing device (step S125). The location data registering processor invokes the location data retrieving processing (step S125) and, in response thereto, receives an update flag (step S126). The update flag is the data indicating whether or not the data stored in a location data memory 164 within each of the retrieval devices 102a to 102i has been updated. When the flag is ON, it indicates that the data has been updated and, when the flag is OFF, it indicates that the data has not been updated.

If the update flag received is OFF (OFF in step S127), the processing in the location data registering processor 111 comes to a close. If the update flag received is ON (ON in step S127) but the target location ID is a root location ID (YES in step S128), the processing in the location data registering processor 111 comes to a close.

If, on the other hand, the update flag received is ON (ON in step S127), and the target location ID is not the root location ID (NO in step S128), the location data registering processor 111 sets the child location ID of the target location ID as a target location ID (step S129). The location data registering processor 111 requests the retrieval device that has the child location ID in question as the management location ID to perform the location data registering processing.

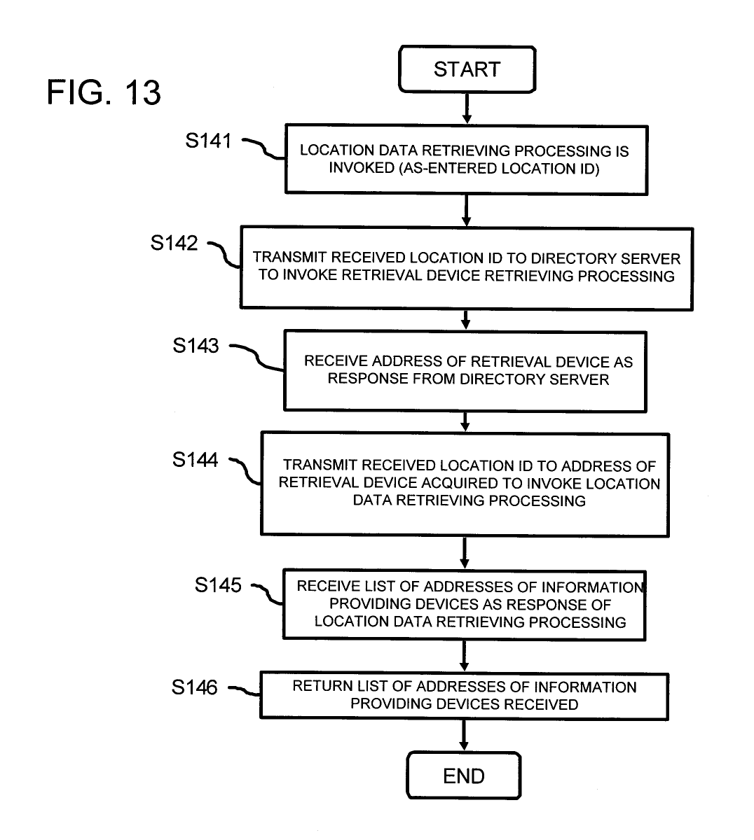

FIG. 13 shows the flow of processing to be executed by the location data retrieving processor 112. When the retrieval controller 105 has received an inquiry into an address of an information providing device, specifying the location ID, the location data retrieving processing by the location data retrieving processor 112 is invoked (step S141).

The location data retrieving processor 112 then transmits to the directory server 106 the received location ID to invoke the retrieval device retrieving processing (step S142). In response thereto, the location data retrieving processor acquires the address of the retrieval device (step S143).

In response to the above mentioned address of the retrieval device acquired, the location data retrieving processor 112 transmits the received location ID to the as-acquired retrieval device address to invoke the location data retrieving processing (step S144). In response thereto, the location data retrieving processor 112 receives a list of the addresses of the information providing devices (step S145).

Then, as a response, the location data retrieving processor 112 returns the list of the addresses of the retrieval devices received (step S146) to the source of invocation to terminate the processing.

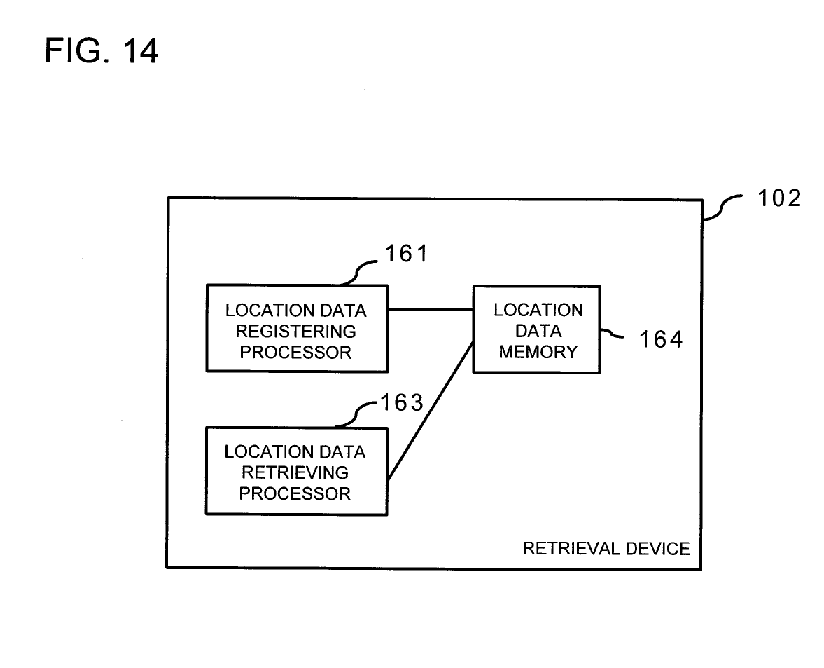

FIG. 14 shows a formulation of a retrieval device 102. Referring to FIG. 14, the retrieval device 102 includes a location data registering processor 161, a location data retrieving processor 163 and a location data memory 164. As compared to the formulation of the retrieval device of the exemplary embodiment 1, shown in FIG. 2, the present exemplary embodiment lacks in the child retrieval device memory. The reason is that, since the retrieval controller 105 and the directory server 106 are now provided, it is unnecessary for the individual retrieval devices 102 to hold the descendant retrieval devices.

In the location data memory 164, there is stored the data similar to that stored in the location data memory 13 of FIG. 3 already explained in the exemplary embodiment 1.

Based on the received location ID and the received addresses of the information providing devices, the location data registering processor 161 updates the data stored in the location data memory 164.

The location data retrieving processor 163 returns, as a response, the address of the information providing device correlated with the received location ID stored in the location data memory 164.

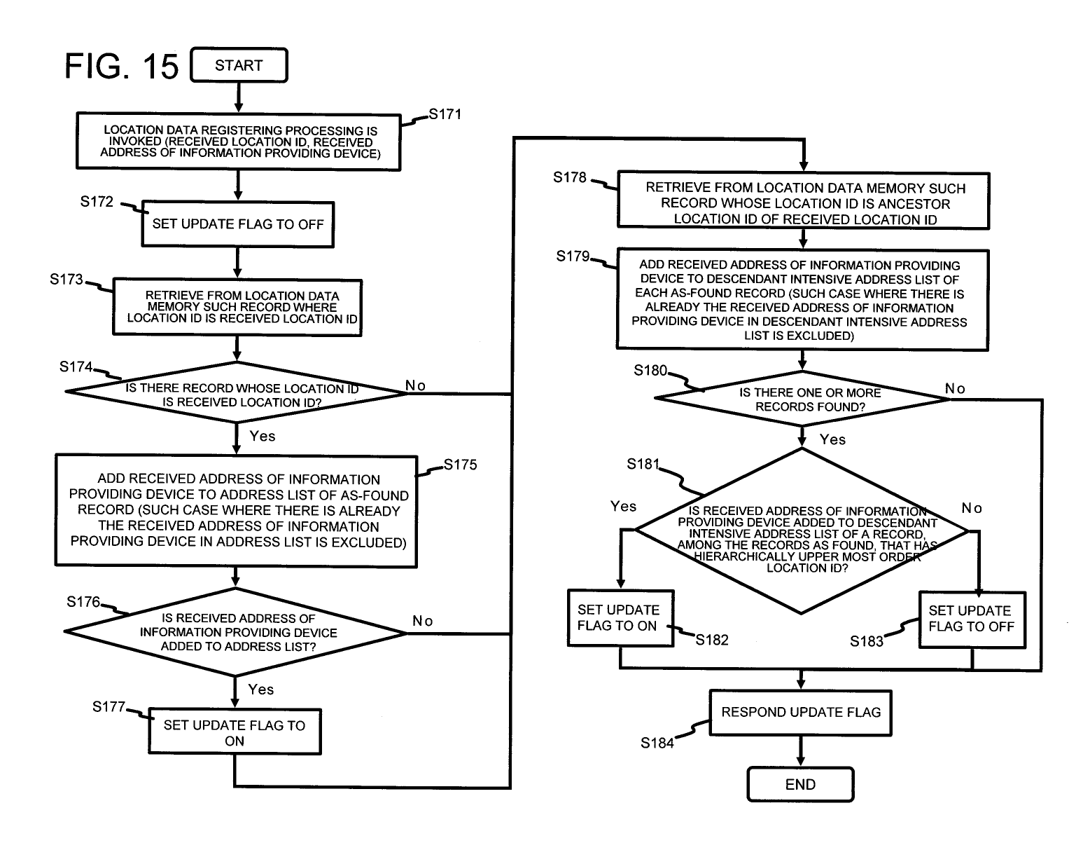

The registering processing carried out by the retrieval device 102 will now be described. FIG. 15 shows the flow of processing performed by the location data registering processor 161.

When the retrieval device 102 has received the address of the information providing device that holds the location ID and an event that states the location ID, the location data registering processing by the location data registering processor 161 is invoked (step S171). The location ID received and the address of the information providing device received are termed the ‘received location ID’ and the ‘received address of the information providing device’, respectively.

The location data registering processor 161 then initializes the update flag to OFF (step S172).

The processing operations from the step S173 to the step S175 are respectively the same as those of the steps S44, S45 and S48 of FIG. 7 in the location data registering processing by the retrieval device 2 of the exemplary embodiment 1. In case the received address of the information providing device has been added to the address list in the step S175 (YES of the step S176), the location data registering processor 161 changes the update flag to ON (step S177).

If there is no record match to the received location ID (NO of step S174), no received address of the information providing device has been added to the address list (NO of step S176) or if change of the update flag has been finished, the location data registering processor 161 retrieves, from the location data memory 164, such a record in which the location ID is an ancestor location ID of the received location ID (step S178). The location data registering processor then adds the received address of the information providing device to the descendant intensive address list of each record as found (step S179). These processing operations are the same as those of the steps S42, S43 and S48 of FIG. 7 in the location data registering processing of the retrieval device 2 of the exemplary embodiment 1.

In case one or more records have been found in the step S178 (YES of step S180), and the received address of the information providing device has been added to the descendant intensive address list of the record having a hierarchically upper most order location ID, out of the records as found (YES of step S181), the location data registering processor 161 sets the update flag to ON (step S182).

If, on the other hand, at least one record has been found in the registering processing in the step S179 (YES of step S180), but a received address of the information providing device has not been added to the descendant intensive address list of the record, among the records as found, which has the hierarchically upper most order location ID (NO of step S181), the location data registering processor 161 sets the update flag to OFF (step S183). If the received address of the information providing device is contained in the address list of the record of the location data memory 164 that has the ancestor location ID of the received location ID as the location ID, the received address of the information providing device is necessarily contained in the address list of the record of the location data memory 164 having the ancestor location of the received location ID as the location ID. Thus, if, in case the location data memory 164 of the retrieval device 102 holds a record composed of the ancestor location ID of the received location ID and an address list containing the received address of the information providing device, the location data registering processing is performed on the ancestor retrieval device of the above mentioned retrieval device, the location data memory 164 of the retrieval device in question is not altered, Hence, the location data registering processing for the ancestor retrieval device is unneeded. This accounts for the update flag being set to OFF.

Ultimately, the location data registering processor 161 returns the update flag to the retrieval controller 105, as the source of invocation, by way of response (step S184).

Thus, in the location data registering processing in the present exemplary embodiment, as compared to the location data registering processing of the exemplary embodiment 1, there is added the processing of the step S176, step S177 and the steps S180 to 184. The processing of these steps updates an update flag that indicates whether or not the location data registering processing is to be carried out in a parent retrieval device of the retrieval device which is executing the present location data registering processing On the other hand, the processing (steps S46 and 47 of FIG. 7) of invoking the location data registering processing of a retrieval device different from the retrieval device that executes the location data registering processing in the exemplary embodiment 1 is carried out by a retrieval controller (steps S127 to S129 of FIG. 12). Hence, the processing is unneeded.

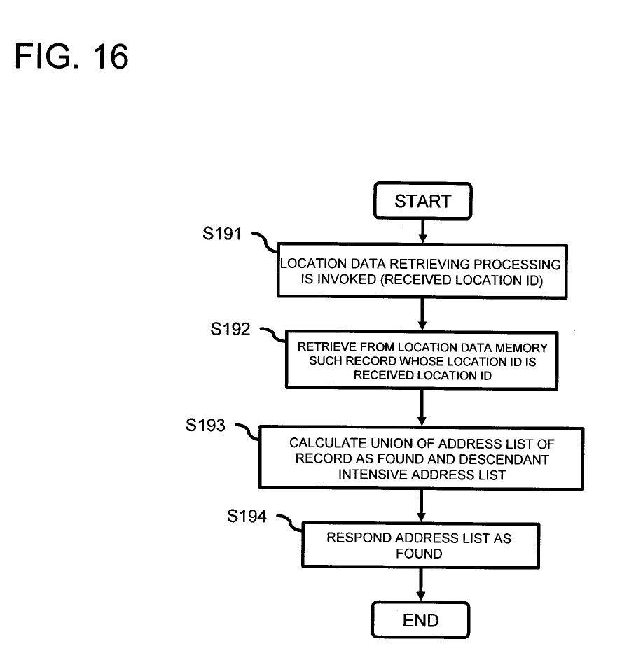

FIG. 16 shows the flow of the processing performed in the location data retrieving processor 163. When the retrieval device 102 has received an inquiry into the address of the information providing device, specifying the location ID, the location data retrieving processing by the location data registering processor 163 is invoked (step S101). Here, the location ID received is termed the ‘received location ID’.

The location data retrieving processor 163 then retrieves, from the location data memory, a record whose location ID is the received location ID (step S192).

The location data retrieving processor 163 then finds a union of the address list of the record as found and the descendant intensive address list (step S193) and returns the union thus found to the retrieval controller 105, which is the source of invocation, as response (step S194).

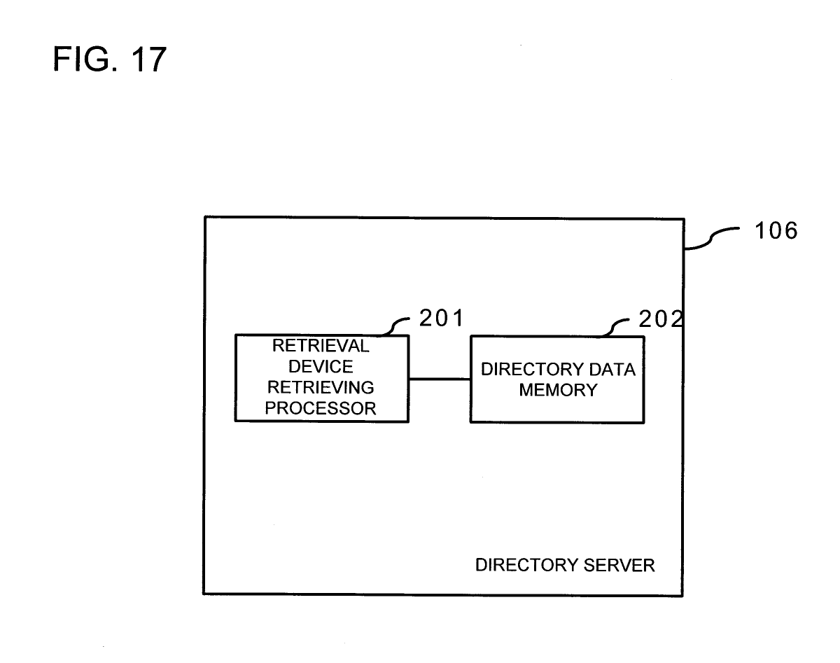

FIG. 17 shows a formulation of the directory server 106. Referring to FIG. 17, the directory server 106 includes a retrieval device retrieving processor 201 and a directory data memory 202.

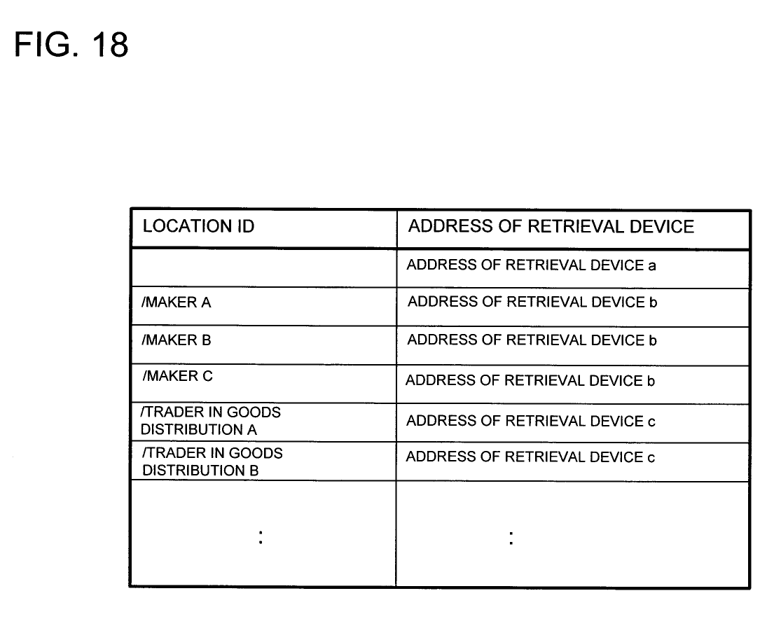

FIG. 18 shows the example data stored in the directory data memory 202 of the directory server 106. As in the child retrieval device memory 14 of the above described exemplary embodiment 1, a plurality of records, each of which is data formed by the location ID and the address of the retrieval device, are stored in the directory data memory 202 to render it possible to find the retrieval device 102 that manages the location IDs.

The retrieval device retrieving processor 201 references the directory data memory 202 to read out and return an address of the retrieval device as a target for retrieval.

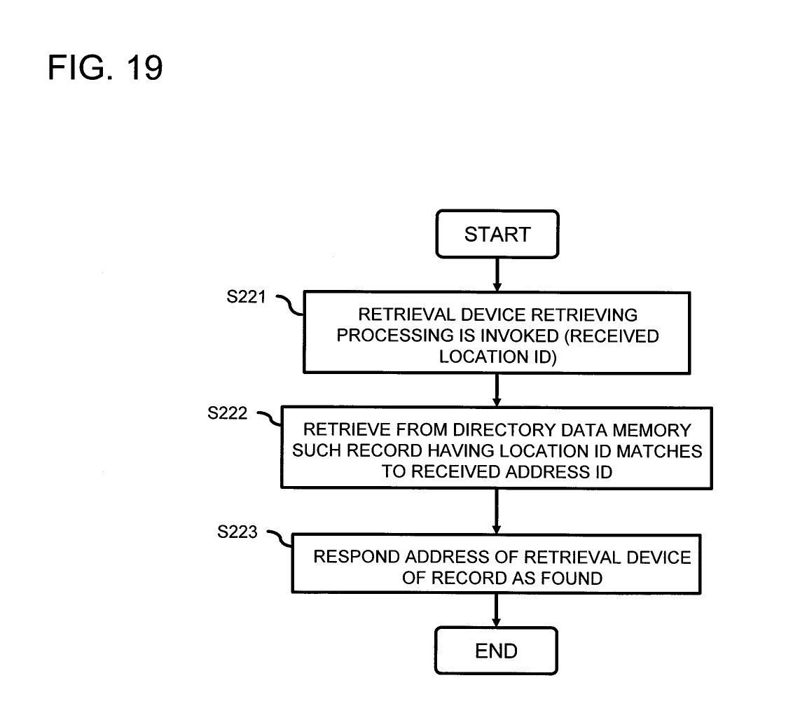

FIG. 19 shows the flow of processing carried out in the retrieval device retrieving processor 201. When the directory server 106 has received, from the retrieval controller 105, a request for retrieving the retrieval device, specifying a location ID, the retrieval device retrieving processing by the retrieval device retrieving processor 201 is invoked (step S221). The location ID received is termed the ‘received location ID’.

The retrieving processor 201 retrieves, from the directory data memory 202, such a record that has the location ID is the received location ID (step S222) to return the address of the retrieval device of the record as found by way of a response (step S223).

In the present exemplary embodiment, the single directory server 106 uniquely manages the directory data. However, the directory data may separately be managed by a plurality of servers. As the directory server 106, pre-existing directory techniques, such as Domain Name System (DNS), may be used.

With the above described exemplary embodiment 2, the number of the retrieval devices invoked in registering the location data may be made smaller than in the exemplary embodiment 1 described above. The reason is that the retrieval controller retrieving the retrieval device that manages the location ID and a directory server are additionally used.

### Exemplary Embodiment 3

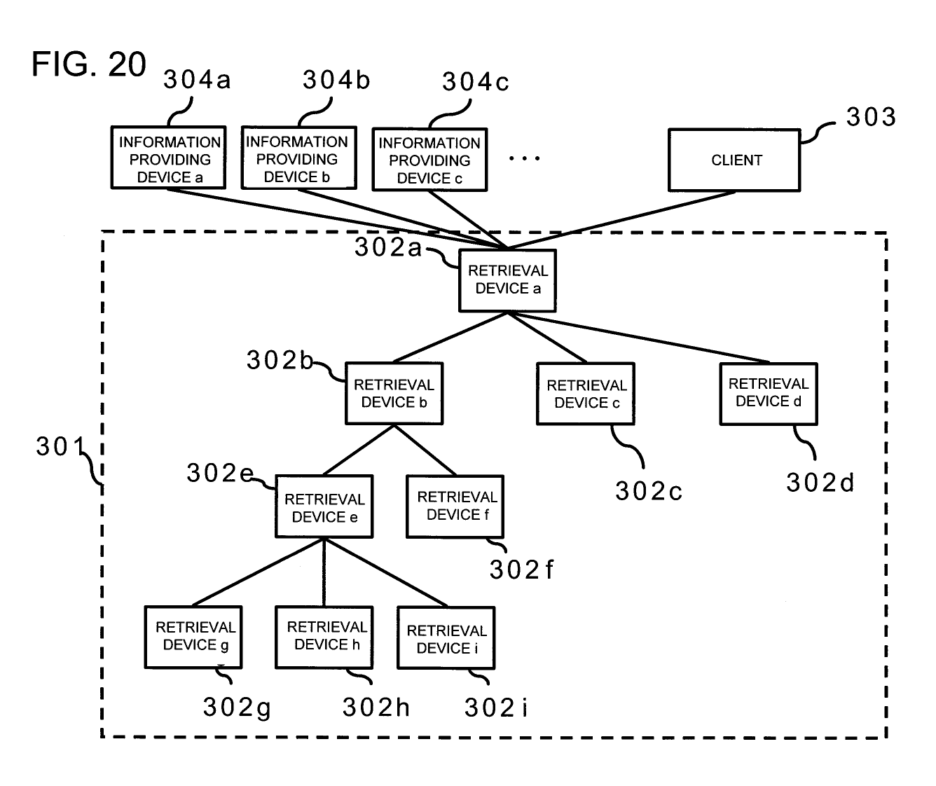

An exemplary embodiment 3, in which new functions are added to the individual retrieval devices of the above described exemplary embodiment 1, will now be described with reference to the drawings. FIG. 20 shows an example formulation of the exemplary embodiment 3 of the present invention that has the basic formulation similar to that of the exemplary embodiment 1.

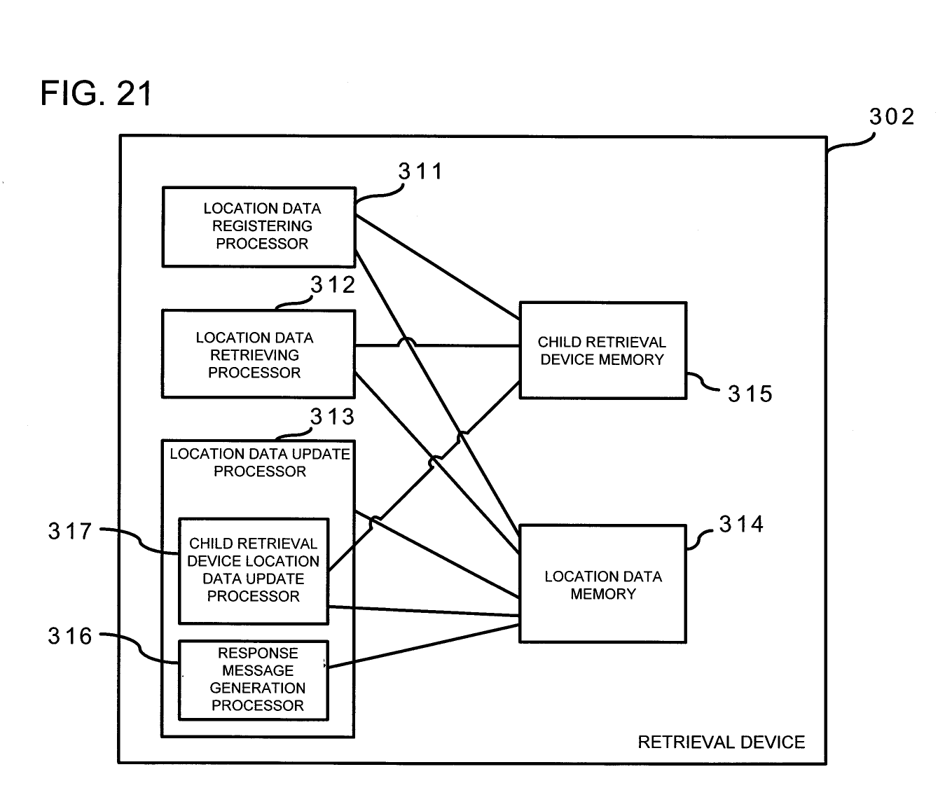

FIG. 21 shows the formulation of the retrieval device included in the retrieval system of the exemplary embodiment 3 of the present invention. Referring to FIG. 21, there is shown a retrieval device 302 including a location data registering processor 311, a location data retrieving processor 312, a location data update processor 313, a location data memory 314 and a child retrieval device memory 315.

The location data update processor 313 includes a child retrieval device location data update processor 317 and a response message generation processor 316.

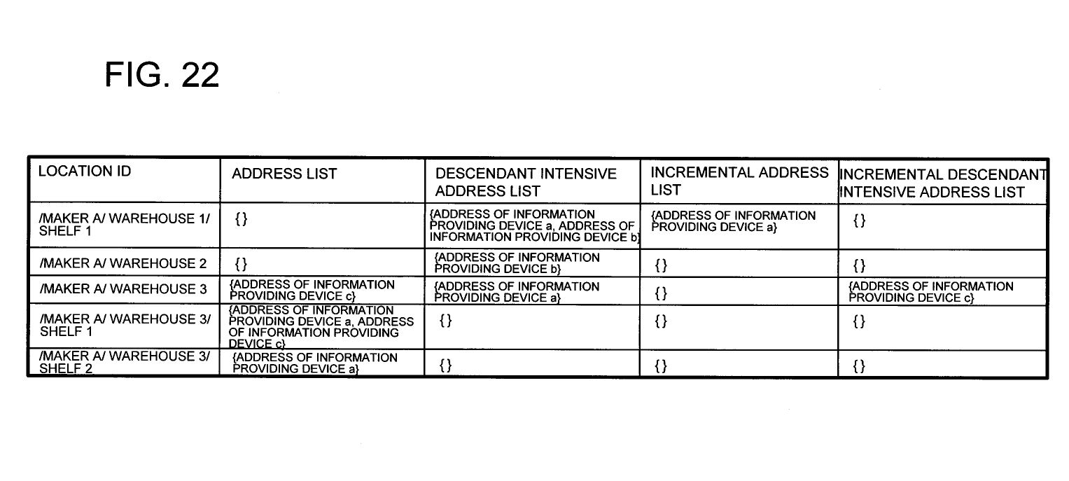

FIG. 22 shows the example data stored in the location data memory 314. In this location data memory 314 of the present exemplary embodiment, there are stored an incremental address list and an incremental descendant intensive address list in addition to the location ID, address list and the descendant intensive address list, stored in the location data memory 13 of the retrieval device of the above described exemplary embodiment 1. The incremental address list and the incremental descendant intensive address list are lists of addresses of the information providing devices newly added based on the data notified from the information providing devices. The addresses in these lists are those not as yet notified at the relevant time point to the ancestor retrieval device of the retrieval device holding the lists.

In the child retrieval device memory 315, there are stored a plurality of records each of which is data made up of a location ID and an address of a retrieval device. In the child retrieval device memory 315, there are stored data similar to those stored in the child retrieval device memory 14 shown in the exemplary embodiment 1 (FIG. 5).

If, in the location data registering processor 311, the received location ID is a management location ID of the own retrieval device, the location data registering processor 311 updates the location data of the own retrieval device. If the received location ID is the management location ID of the retrieval device having the location data registering processor 311 as its constituent element, the location data registering processor updates the location data held by the retrieval device. In case the received location ID is not the management location ID of the retrieval device, the location data registering processing is executed by the child retrieval device associated with the location ID. In the exemplary embodiment 1, the location data registering processing adds the address of the information providing device to the address list stored in the location data memory 13 or to the descendant address list. In the present exemplary embodiment, the location data registering processing adds the address of the information providing device to the address list stored in the location data memory 13 or to the descendant intensive address list. In the present exemplary embodiment, the location data registering processing adds the address list of the information providing device to the incremental address list stored in the location data memory 314 or to the descendant incremental intensive address list as well.

In case the received location ID is a management location ID of a retrieval device having the location data retrieving processor 312 as its constituent element, the location data retrieving processor 312 updates the data of the location data memories of the retrieval device and the retrieval devices hierarchically lower in order than the retrieval device. The location data retrieving processor 312 also returns an address list of the information providing devices as target of retrieval by way of a response. In case the received location ID is not the management location ID of the own retrieval device, the location data retrieving processor 312 selects a child retrieval device as the target of retrieval to execute the location data retrieving processing on the so selected child retrieval device.

The location data update processor 313 invokes the location data update processing from the child retrieval device of the retrieval device that has the location data update processor 313 as a constituent element. The location data update processor 313 then combines the address of the information providing device, received as a response, and a non-updated address of an information providing device of the retrieval device, and transmits the resulting address of the information providing device to a parent retrieval device.

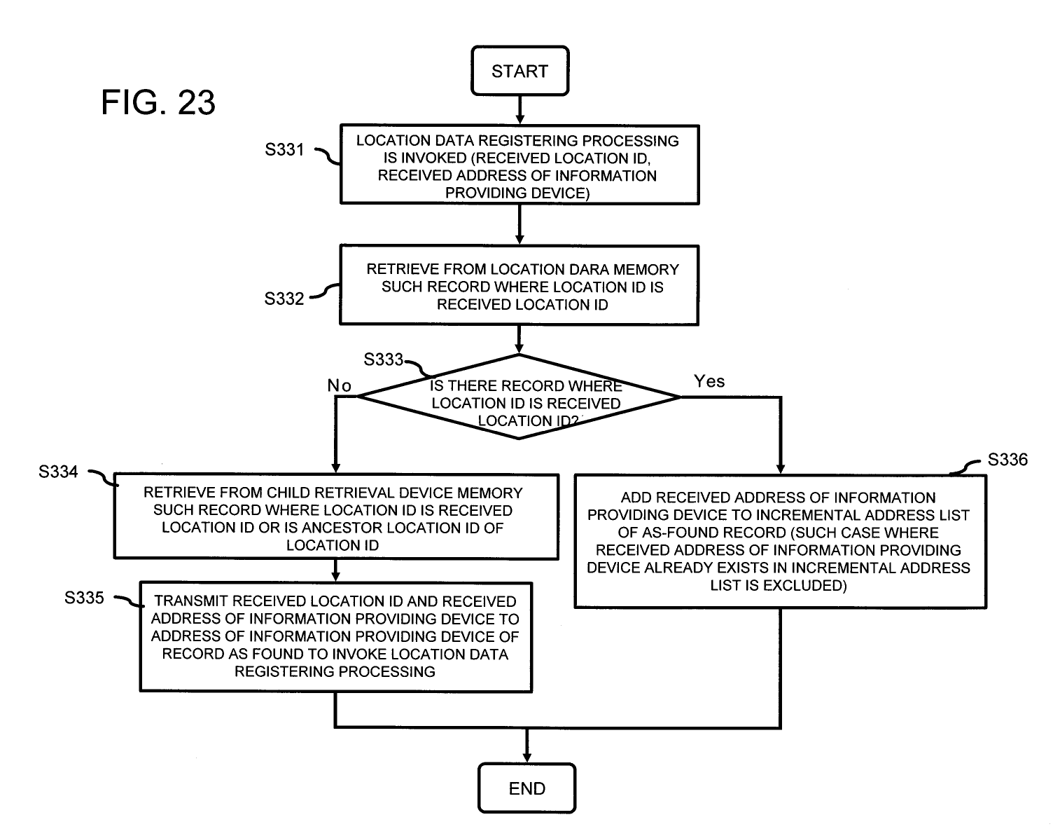

FIG. 23 shows the flow of processing executed by the location data registering processor 311. The basic flow is similar to the location data registering processing carried out in the retrieval device 2 of the exemplary embodiment 1 shown in FIG. 8. However, the steps S42 and S43 of updating the descendant intensive address list are eliminated from the location data registering processing carried out in the retrieval device 2 of the exemplary embodiment 1 shown in FIG. 7. On the other hand, the processing in the step S336 corresponds to that in the step S48 of FIG. 7 in which the address list of the step S48 is replaced by the incremental address list.

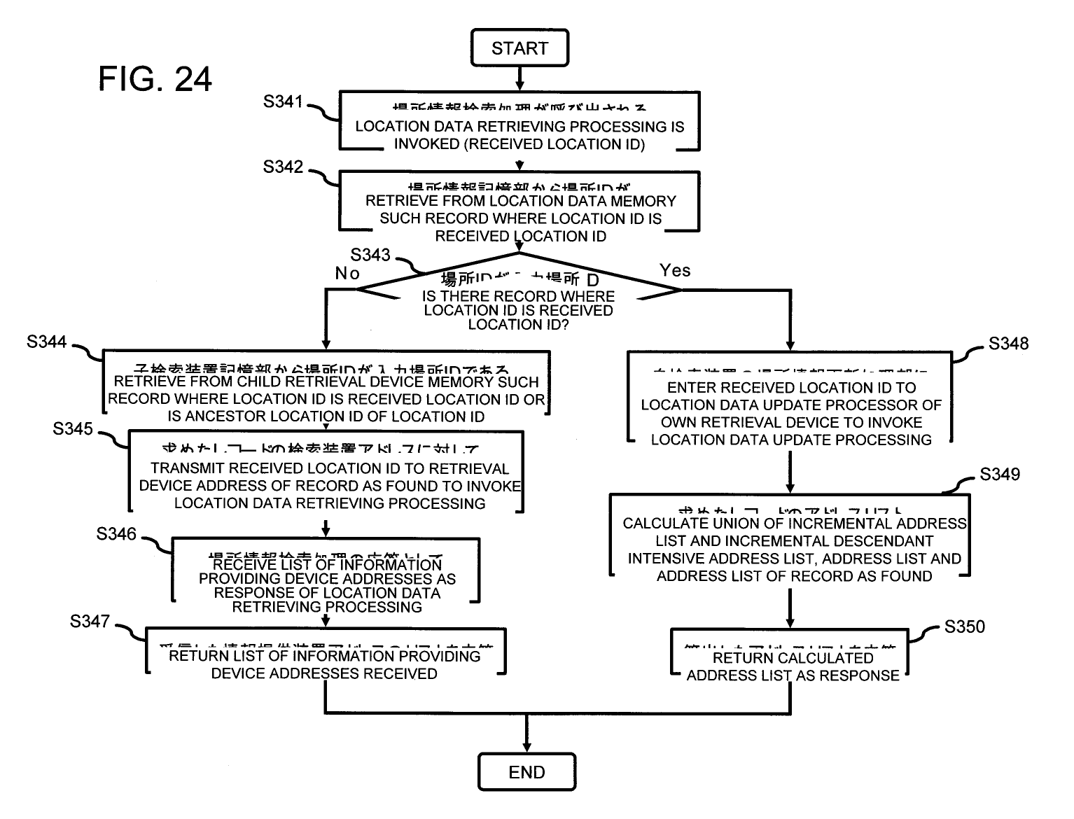

FIG. 24 shows the flow of the location data retrieving processing executed by the location data retrieving processor 312. The basic flow is similar to the location data retrieving processing carried out in the retrieval device 2 of the exemplary embodiment 1 shown in FIG. 8. However, in the flow of FIG. 24, the processing of entering a received location ID to the location data update processor of the retrieval device to invoke the location data update processing (step S348) is added directly ahead of the step S68 of the location data retrieving processing in the retrieval device 2 of the exemplary embodiment 1 shown in FIG. 8. Moreover, in a step S349 of FIG. 24, not the union of the address list and the descendant intensive address list in the retrieval device 2 of the exemplary embodiment 1 shown in FIG. 8 (see the step S68 of FIG. 8), but the union of an incremental address list and an incremental descendant intensive address list is calculated.

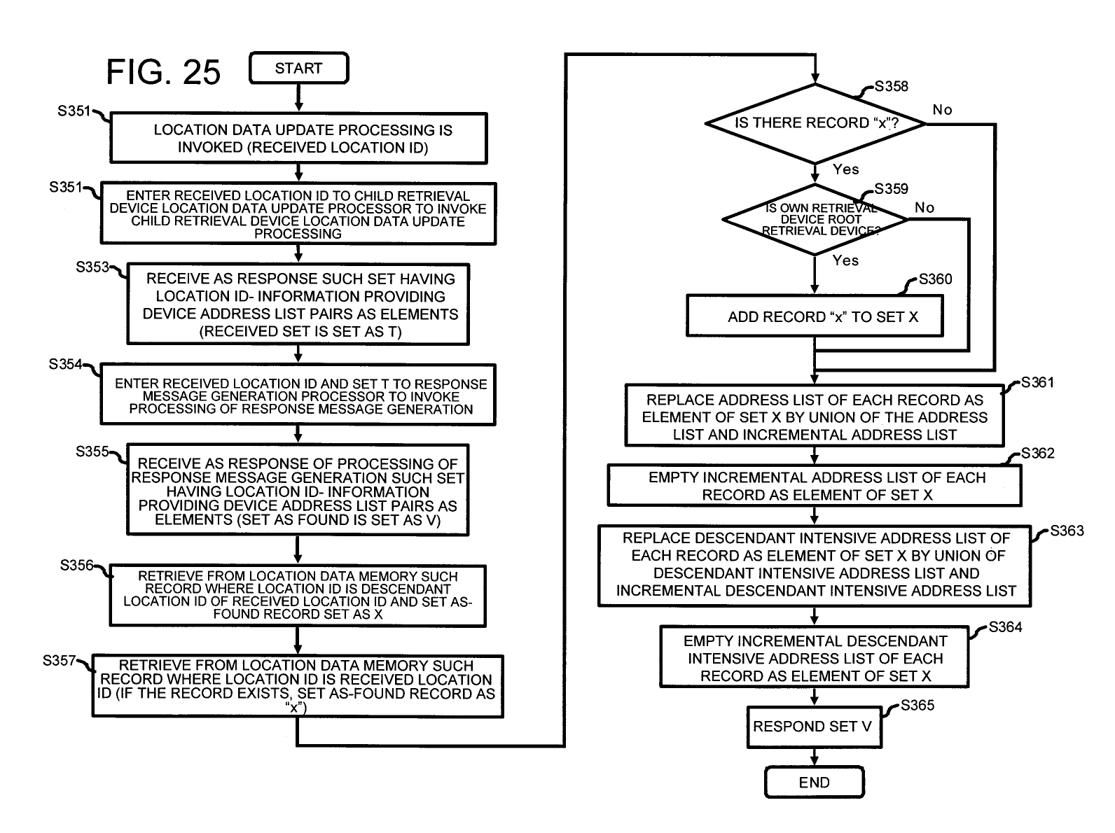

FIG. 25 shows the flow of location data update processing carried out in the location data update processor 313. Initially, the location data update processing, specifying a location ID, is invoked (step S351). The location ID received is entered to the child retrieval device location data update processor 317 to invoke the child retrieval device location data update processing (step S352). The location ID received is herein termed the ‘received location ID’.

The location data update processor 313 then receives, as response from the child retrieval device location data update processor 317, a set whose elements are location ID/information providing device address list pairs (step S353). The set received is herein set as T.

The location data update processor 313 then inputs, at its response message generation processor 316, the received location ID and the set T, to invoke the response message generation processing (step S354). The location data update processor 313 receives, as a response, a set whose elements are location ID/information providing device address pairs, from the response message generation processor 316 (step S355). The set received is herein set as V.

The location data update processor 313 then retrieves, from the location data memory 314, a record whose location ID is a descendant location ID of the received location ID. The location data update processor 313 then sets the as-found record set as X (step S356). The location data update processor 313 then retrieves, from the location data memory 314, a record whose location ID is the received location ID (step S357). If such record exists, the as-found record is set as “x”.

If, as a result of the above retrieval, there exists the record “x” (YES of the step S358), and the retrieval device that executes the present location data update processing is the root retrieval device (YES of the step S359), the location data update processor 313 adds the record “x” to the set X (step S360).

The location data update processor 313 then replaces an address list of each record, as an element of the set X, by a union of the address list and an incremental address list (step S361), and subsequently empties the incremental address list (step S362).

The location data update processor 313 then replaces a descendant intensive address list of each record, as an element of the set X, by a union of a descendant intensive address list and an incremental descendant intensive address list (step S363), and subsequently empties the incremental descendant intensive address list (step S364).

The location data update processor then returns the set V to the source of invocation (step S365) as a response to terminate the location data update processing.

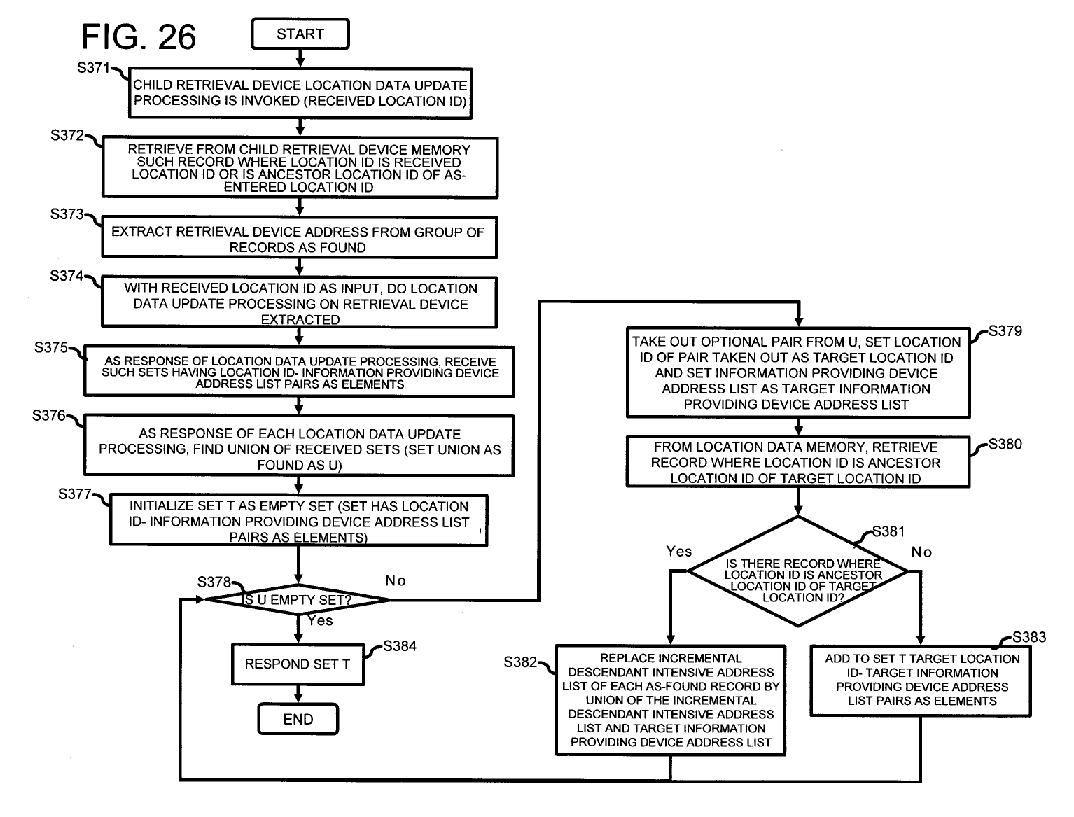

FIG. 26 shows the flow of the child retrieval device location data update processing as carried out in the child retrieval device location data update processor 317. Initially, the child retrieval device location data update processing, specifying the location ID, is invoked (step S371). The child retrieval device location data update processor 317 retrieves, from the child retrieval device memory 315, such a record whose location ID is the received location ID or a descendant location ID of the received location ID (step S372). The location ID received is herein termed the ‘received location ID’.

The child retrieval device location data update processor 317 then extracts the retrieval device address from the group of the as-found records (step S373). The child retrieval device location data update processor 317 then executes the location data update processing (step S374) for the retrieval device, identified by each extracted retrieval device address, using the received location ID as an input. The child retrieval device location data update processor then receives, as a response, a set whose elements are location ID-information providing device address list pairs (step S375).

The child retrieval device location data update processor 317 then finds a union of sets received in response to the location data update processing operations in the respective retrieval devices, and sets the so found union as U (step S376). The child retrieval device location data update processor 317 then sets the set T as blank sets by way of initialization (step S377). It is noted that the set T has the location ID/information providing device address list pairs as elements.

The processing operations from step S379 until step S383 are then repeated until the set U becomes an empty set. In case the set U has become the empty set (YES of the step S378), the set T is returned to the source of invocation by way of a response (step S384) to terminate the child retrieval device location data update processing.

In the step S379, an optional pair is taken out from the set U. The location ID of the so taken out pair is set as the target location ID, and the address list of the information providing devices is set as the target information providing device address list.

The child retrieval device location data update processor 317 then retrieves, from the location data memory 314, a record whose location ID is an ancestor location ID of the target location ID (step S380).

If, as a result of the step S380, there exists a record whose location ID is the ancestor location ID of the target location ID (YES of the step S381), a union of the incremental descendant intensive address list and the address list of the target information providing devices is substituted for the incremental descendant intensive address list of the as-found records (step S382).

If, as a result of the step S380, there exists no record whose location ID is the ancestor location ID of the target location ID (NO of step S381), the object location ID/target information providing device address list pairs are added as elements to the set T (step S383).

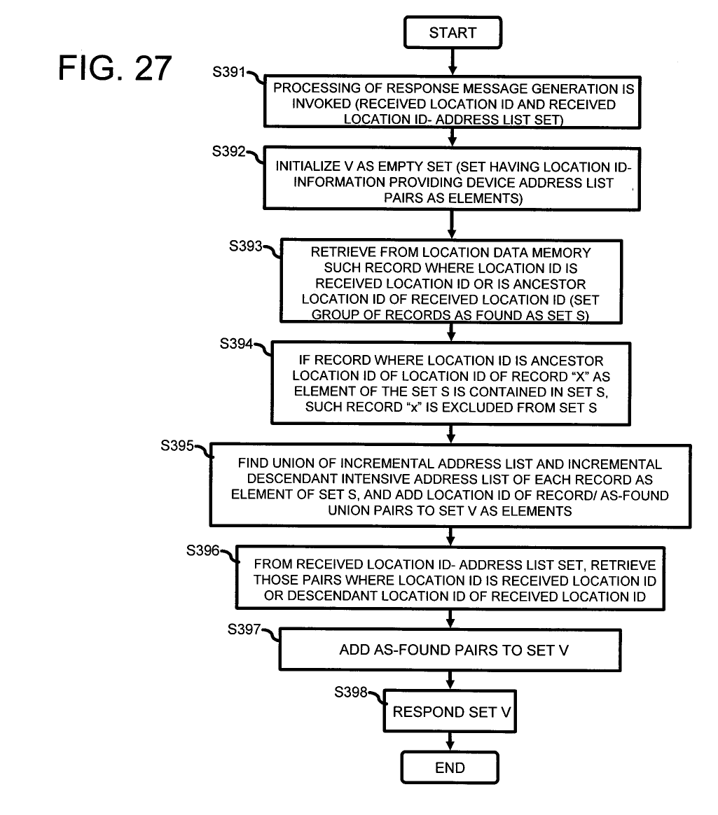

FIG. 27 shows the flow of the processing of generating response messages executed by the response message generation processor 316. Initially, the processing of response message generation is invoked along with a set having the location ID/information providing device address list pairs as elements (step S391). The location ID received is termed the ‘received location ID’, while the set having the location ID/information providing device address list pairs as elements is termed the ‘location ID/address list set’.

The response message generation processor 316 then initializes the set V as an empty set (step S392). The set V has the location ID/information providing device address list pairs as elements. From the location data memory 314, such a record where the location ID is a received location ID or a descendant location ID of the received location ID is retrieved, and the group of the records thus found is set as a set S (step S393).

If a record whose location ID is an ancestor location ID of the location ID of the record “x”, which is an element of the set S, is contained in the set S, such record “x” is deleted from the set S (step S394). A union of an incremental address list of records as elements of the set S and its incremental descendant intensive address list is then found. A record location ID/as-found union pairs is added to the set V as its elements (step S395).

The response message generation processor 316 retrieves, from the location ID/address list set, those pairs in which the location ID is the received location ID or a descendant location ID of the received location ID (step S396). The pairs, thus found, are added to the set V (step S397).

Finally, the set V is returned to the source of invocation by way of a response (step S398) to terminate the processing for response message generation.

In the present exemplary embodiment, only the variation from the previous processing for location data retrieval is updated such as to lower the cost of the location data retrieval processing. Also, in the location data registration, there is no need to update the descendant intensive address list for each retrieval device accessed until getting to the retrieval device with coincident location IDs. Hence, the cost incurred in the location data registering processing becomes lower than that incurred in the exemplary embodiment 1.

In case goods are managed using RFID tags, the information providing device has to handle an event containing the RFID for discrimination of goods or the time when or the place where the RFID tags have been read. It may thus be feared that the volume of the events will be overly increased with increase in the number of the objects being managed, thus possibly increasing the frequency of the operations of the location update processing for the retrieval system. The present exemplary embodiment is particularly effective in case the frequency of registration becomes higher than that of retrieval.

### Exemplary Embodiment 4

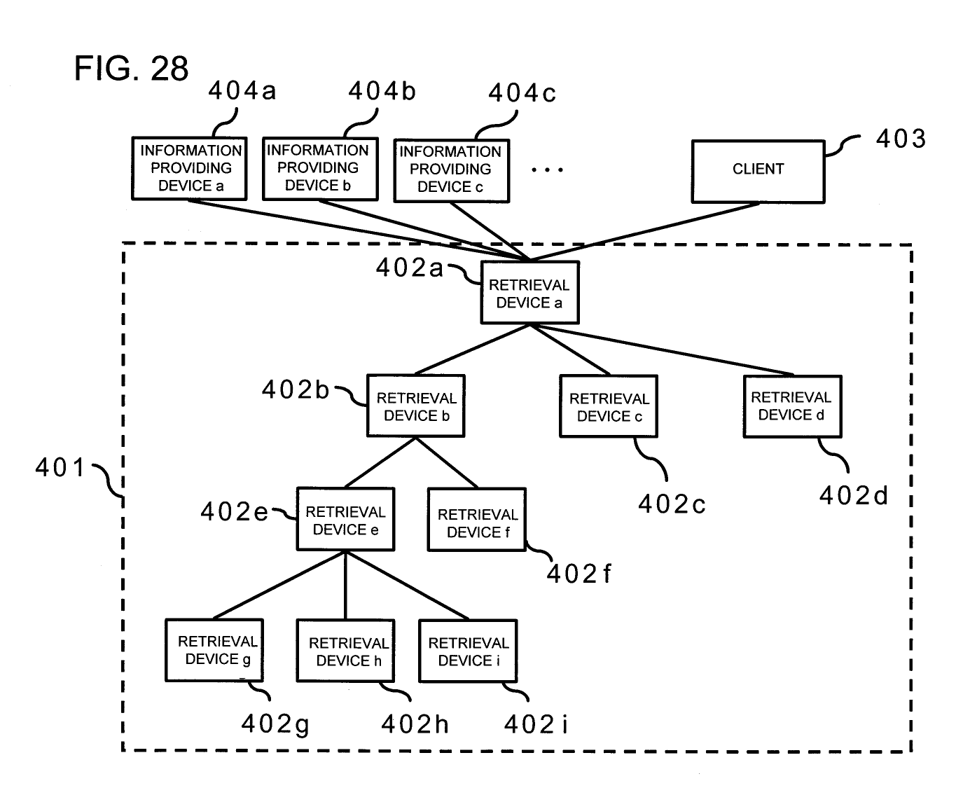

An exemplary embodiment 4, in which new functions are added to the individual retrieval devices of the above described exemplary embodiment 1, will now be described with reference to the drawings. FIG. 28 shows an example formulation of the exemplary embodiment 4 of the present invention. The present exemplary embodiment has the basic formulation in common with the above described exemplary embodiments 1 and 3.

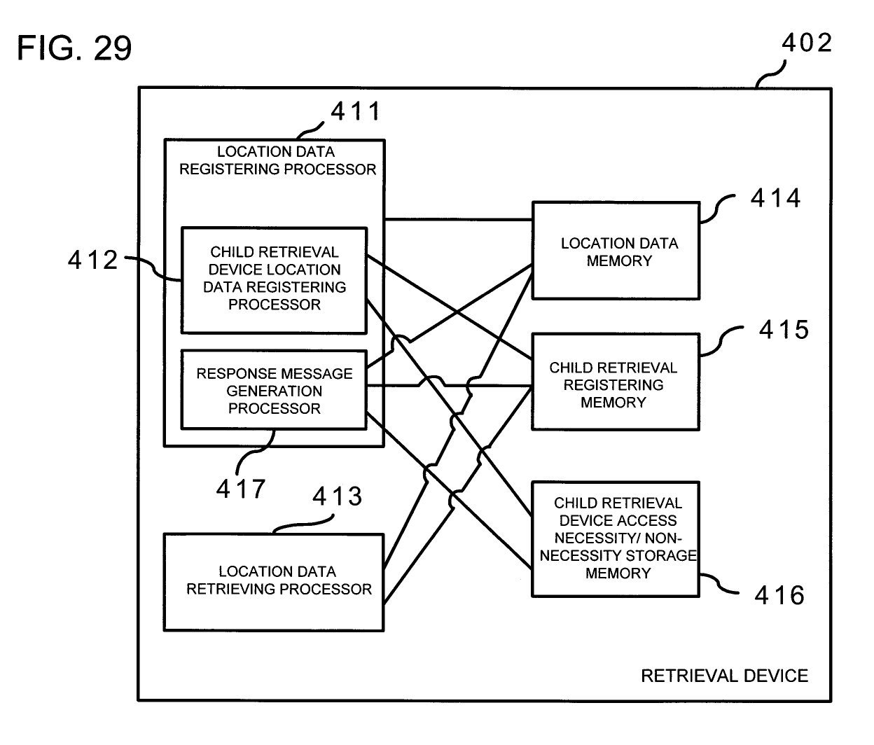

FIG. 29 shows a formulation of a retrieval device contained in the retrieval system of the exemplary embodiment 4 of the present invention. Referring to FIG. 29, there is shown a retrieval device 402 including a location data registering processor 411, a location data retrieving processor 413, a location data memory 414, a child retrieval registering processor 415 and a child retrieval device access necessity/non-necessity storage memory 416. The memory 416 is equivalent to a child data processing device access necessity/non-necessity storage memory which appears in the claim wording.

The location data registering processor 411 includes a child retrieval device location data registering processor 412 and a response message generation processor 417.

Similarly to the location data memory 13, the location data memory 414 stores a plurality of records each of which is data composed of a location ID, an address list and a descendant intensive address list.

Similarly to the child retrieval device memory 14 of the exemplary embodiment 1, described above, the child retrieval memory 415 stores a plurality of records each of which is data composed of a location ID and an address of the retrieval device having the location ID as the management location ID.

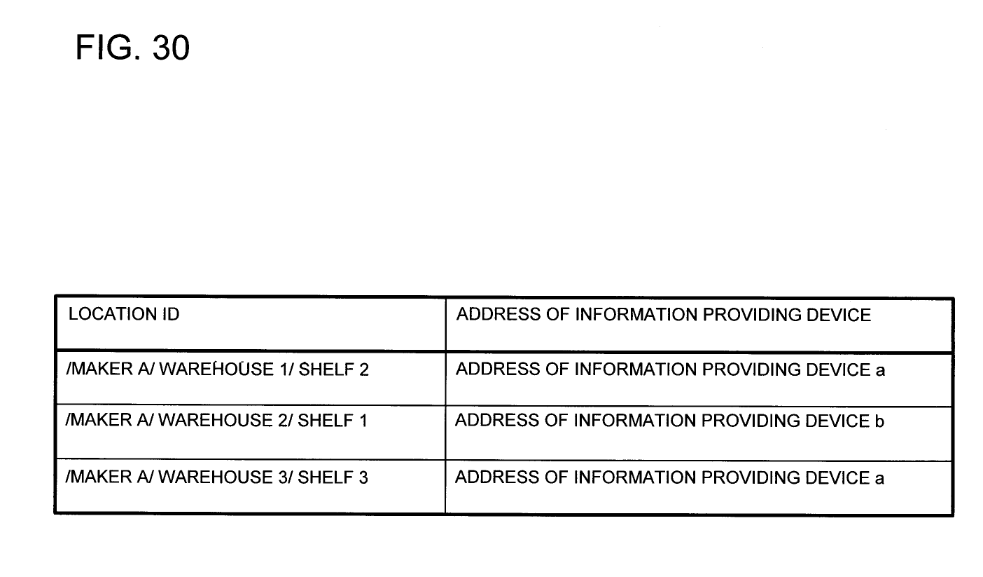

The child retrieval device access necessity/non-necessity storage memory 416 stores a plurality of records each of which is data composed of a location ID and an address of the information providing device (see FIG. 30). Suppose that a record in which the location ID is “x” and the address of the information providing device is “y” is stored in the child retrieval device access necessity/non-necessity storage memory 416. Such state indicates that the address of the information providing device “y” is contained in the address list of the record of the location data memory 414 that has the location ID “x” or the descendant location ID of the location ID “x” as the location ID.

The location data registering processor 411 updates the data of the location data memory 414 based on the received location ID and the received address of the information providing device. In case the received location ID is not the management location ID of the retrieval device that executes the present processing, the location data registering processor 411 executes the location data registering processing of the child retrieval device correlated with the received location ID. However, if the location data registering processor 411 has referenced the child retrieval device access necessity/non-necessity storage memory 416 before executing the above processing, and has determined that the processing for the child retrieval device is unnecessary, the location data registering processor 411 refrains from performing the location registering processing for the child retrieval device.

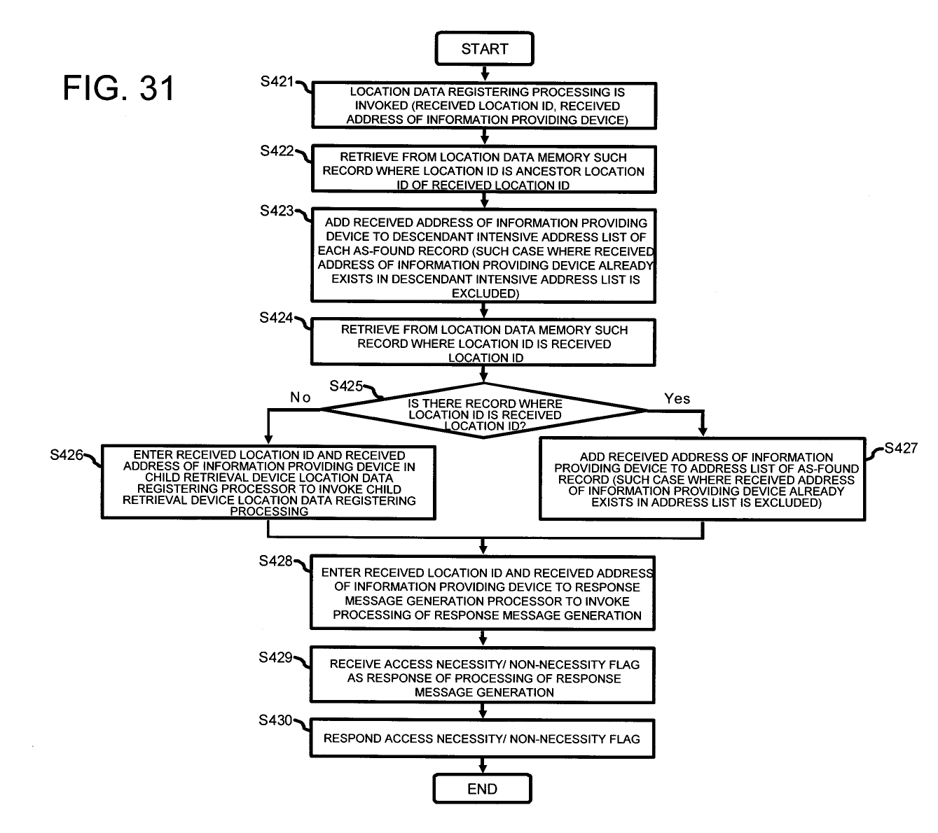

FIG. 31 shows the flow of processing carried out by the location data registering processor 411. The basic flow is similar to that of the location data registering processing in the retrieval device 2 of the exemplary embodiment 1 shown in FIG. 7. However, the processing of the present exemplary embodiment differs from that of the exemplary embodiment 1 as regards the processing for decision of a step S425 and the ensuing processing.

In case there is no record having the received location ID as location ID (NO of step S425), the location data registering processor 411 delivers the received location ID and the received address of the information providing device to the child retrieval device location data registering processor 412 to invoke the child retrieval device location data registering processing (step S426). In the child retrieval device location data registering processing, it is determined, based on the child retrieval device access necessity/non-necessity storage memory 416, whether or not to perform the location data registering processing for the child retrieval device. In case the decision is for performing the location data registering processing, the location data registering processing for the child retrieval device is performed. The location data registering processor 411 then updates the child retrieval device access necessity/non-necessity storage memory 416, based on the response of the location data registering processing for the child retrieval device.

If conversely there is a record having the received location ID as location ID (YES of the step S425), the location data registering processor 411 adds the received address of the information providing device to the address list of the record as found (step S427). If the received address of the information providing device has already been contained in the address list, such addition is not made.

The location data registering processor 411 then delivers the received location ID and the received address of the information providing device to the response message generation processor 417 to invoke the processing for response message generation. The location data registering processor 411 receives, as a response thereto, a flag indicating the necessity/non-necessity for access (step S429). This flag assumes two values of ‘needed’ and ‘unneeded’. The value ‘needed’ indicates that there is necessity for performing the location data registering processing, while the value ‘unneeded’ indicates that there is no such necessity.

The location data registering processor 411 then returns the flag indicating the necessity/non-necessity for access to the destination of invocation as a response (step S430) to terminate the location data registering processing.

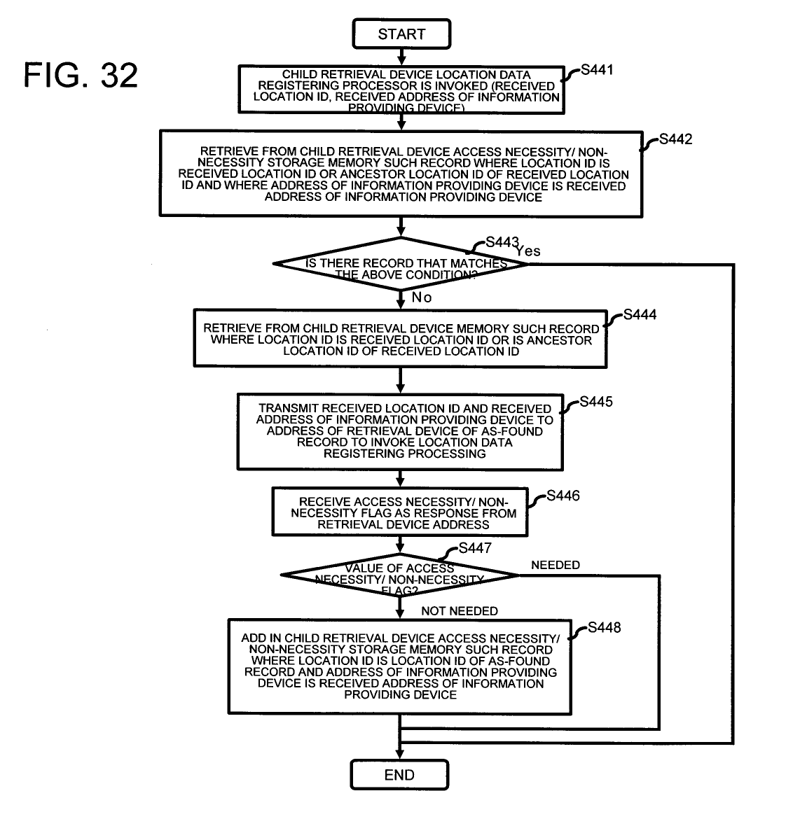

FIG. 32 shows the flow of processing executed by the child retrieval device location data registering processor 412. If, with the delivery of the location ID and the address of the information providing device, the processing for registering the child retrieval device location data is invoked (step S441), the child retrieval device location data registering processor 412 retrieves, from the child retrieval device access necessity/non-necessity storage memory 416, such a record in which the location ID is the received location ID or is an ancestor location ID of the received location ID, and in which the address of the information providing device is the received address of the information providing device (step S442). The location ID received is termed the ‘received location ID’, whereas the address of the information providing device received is termed the ‘received address of the information providing device’.

If, as a result of the above mentioned retrieval, there is a record that matches the above condition (YES of the step S443), the child retrieval device location data registering processor 412 terminates the child retrieval device location data registering processing.

If, as a result of the above mentioned retrieval, there lacks a record that matches the above condition (NO of the step S443), the child retrieval device location data registering processor 412 retrieves, from the child retrieval registering processor 415, such a record in which the location ID is the received location ID or an ancestor location ID of the received location ID (step S444).

Then, in response to the address of the information providing device of the as-found record, the child retrieval device location data registering processor 412 transmits the received location ID and the received address of the information providing device. The child retrieval device location data registering processor 412 invokes the location data registering processing (step S445) and, as a response thereto, receives the above mentioned flag indicating the necessity/non-necessity for access (step S446).

If the flag received indicates that accessing is needed (‘necessary’ in the step S447), the child retrieval device location data registering processor 412 terminates the child retrieval device location data registering processing.

If conversely the flag received indicates that accessing is unneeded (‘unnecessary’ in the step S447), the child retrieval device location data registering processor 412 adds, in the child retrieval device access necessity/non-necessity storage memory 416, such a record in which the location ID of the record as found is set as the location ID and in which the received address of the information providing device is set as the address of the information providing device (step S448). The child retrieval device location data registering processing is then terminated.

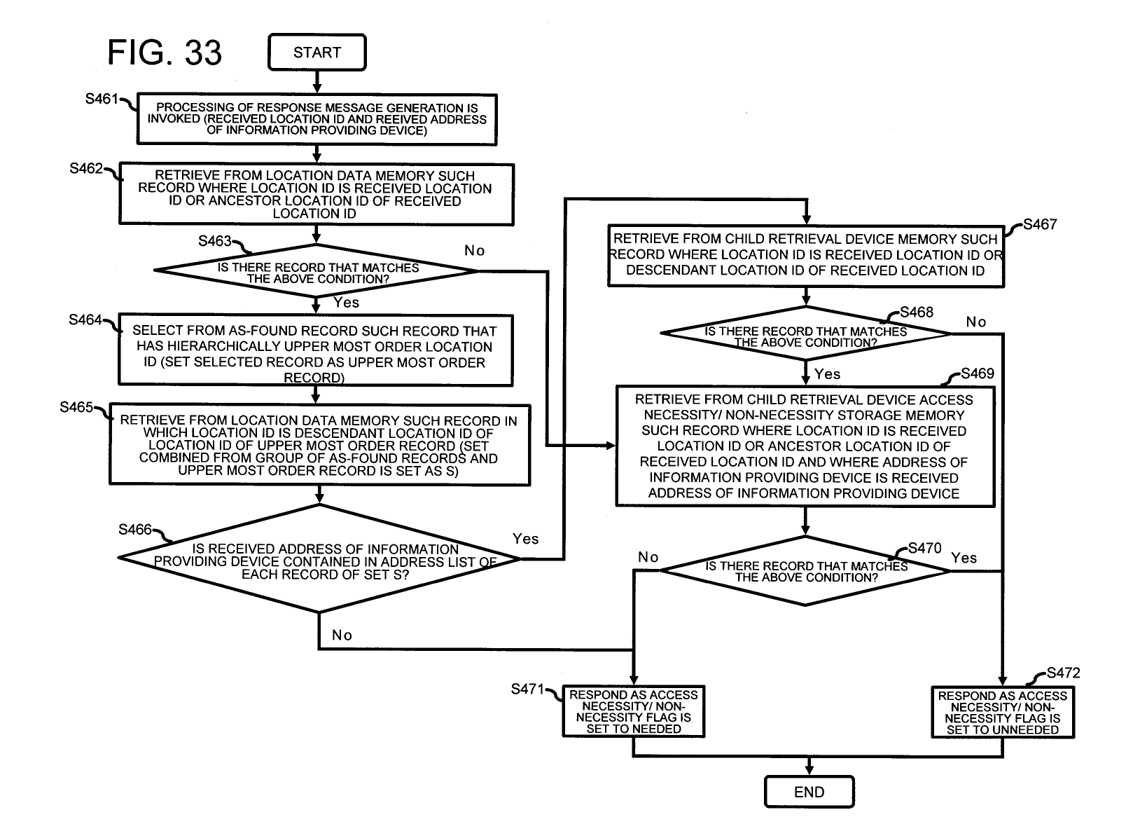

FIG. 33 shows the flow of processing for generating the response message executed by the response message generation processor 417. When the processing for generating the response message, specifying the location ID and the address of the information providing device, is invoked (step S461), the response message generation processor 417 retrieves, from the location data memory 414, such a record in which the location ID is the received location ID or is an ancestor location ID of the received location ID (step S462). The location ID received and the address of the information providing device received are termed the ‘received location ID’ and the ‘received address of the information providing device, respectively.

If the result of the above mentioned retrieval indicates that there exists a record that matches the above mentioned condition (YES of the step S463), the response message generation processor 417 selects, from among the as-found records, such a record that has a hierarchically upper most order location ID (step S464). The so selected record is termed the ‘upper most order record’. If the result of the retrieval indicates that there is no record that matches the above condition (NO of the step S463), the response message generation processor 417 consigns to a step S469.

The response message generation processor 417 then retrieves, from the location data memory 414, such records in each of which the location ID is a descendant location ID of the location ID of the upper most record (step S465). A set of a group of the records, thus found on retrieval, and the upper most order record, combined together, is set as S.

In case the received address of the information providing device is not contained in the address list of the records of the set S (NO of the step S466), the response message generation processor 417 sets the necessity/non-necessity for access indicating flag to “necessary” by way of responding to the source of invocation (step S471) to terminate the processing for response message generation.

In case the received address of the information providing device is contained in the address list of each record of the set S (YES of the step S466), the response message generation processor 417 retrieves, from the child retrieval device memory 415, such a record in which the location ID is the received location ID or is a descendant location ID of the received location ID.

If the result of retrieval indicates that there is no record that matches the above condition (NO of the step S468), the response message generation processor 417 sets the necessity/non-necessity for access indicating flag to ‘unnecessary’ and notifies the source of invocation of that effect as response (step S472) to terminate the processing for response message generation.

If the result of retrieval indicates that there exists a record that matches the above condition (YES of the step S468), the response message generation processor 417 retrieves, from the child retrieval device access necessity/non-necessity storage memory 416, such a record in which the location ID is the received location ID or is an ancestor location ID of the received location ID, and in which the address of the information providing device is the received address of the information providing device (step S469).

If the result of the retrieval indicates that there exists the record that matches the above condition (YES of the step S470), the response message generation processor 417 sets the necessity/non-necessity for access indicating flag to “unnecessary” and notifies the source of invocation of that effect (step S472) as response to terminate the processing for response message generation.

If the result of the retrieval indicates that there exists no record that matches the above condition (YES of the step S470), the response message generation processor 417 sets the necessity/non-necessity for access indicating flag to “necessary” and notifies the source of invocation of that effect (step S471) to terminate the processing for response message generation.

The operation of the location data retrieving processor 413 is similar to that of the location data retrieving processing in the retrieval device 2 of the exemplary embodiment 1 shown in FIG. 8, and hence the corresponding description is dispensed with.

In the present exemplary embodiment, described above, the location data registering processing for retrieval devices of the lower order than a pre-specified retrieval device is not carried out in the location data registering processing. This reduces costs otherwise incurred in the location data registering processing in the retrieval system.

For example, if the preset exemplary embodiment is applied to EPCIS, such a case may be thought of in which a certain maker manages the data of the maker's information by a sole EPCIS server. In such case, the location IDs for “/maker A” and its descendant location IDs, such as “/maker A”, “/maker A/warehouse 1” or “/maker A/warehouse 1/shelf 1”, are managed by the above mentioned EPCIS server. If data registration is performed in such case, no data registering is made in the retrieval devices of the lower order than “/maker A”, thus providing for efficient data registering in the retrieval system.

Although the description has been made of preferred exemplary embodiments of the present invention, such exemplary embodiments are given only by way of illustration and are not intended to limit the scope of the present invention. That is, further modifications, substitutions or adjustments may be made without departing from the basic technical concept of the present invention. For example, the above described exemplary embodiment 3 and 4 may be combined together.

In the above described exemplary embodiments, the location data retrieving processor is provided in the retrieval device. However, the location data retrieving processor may be provided separately. For example, such an arrangement including a data processing device 500, comprised of an identifier-related data memory 501 and a data registering processor 502, may be used. The identifier-related data memory 501 manages identifier/data pairs. The identifier and data are respectively the ‘location ID’ and the address of the information providing device of each of the above described exemplary embodiments. The data registering processor 502 inputs the identifiers and the data and registers the identifiers and the data in the identifier-related data memory 501 based on the identifiers. The data processing device 500 is equivalent to a subset of the retrieval device of each of the above described exemplary embodiments

Although the present invention has been described in connection with its preferred exemplary embodiments, it goes without saying that the present invention is not to be limited to these exemplary embodiments. Rather, the present invention may comprise a variety of alterations or corrections that may occur readily to those skilled in the art within the scope of the invention.
Various changes or adjustments of the exemplary embodiments and examples may be made within the framework of the disclosure of the invention inclusive of claims. Further, a wide variety of combinations or selections of disclosed elements may be made within the framework of the claims and the technical concept of the present invention.

In the following, preferred modes are summarized.

### Mode 1:

Refer to the data processing device of the first aspect.

### Mode 2:

The data processing device according to mode 1, further comprising: a data retrieving processor that retrieves the set of data in the record, the identifier of which is the received identifier, stored in the identifier-related data memory.

### Mode 3:

The data processing device according to mode 2, further comprising: a child data processor memory that stores a plurality of records, each including an identifier and a child data processing device address which is an address of a data processing device hierarchically one level lower than the data processing device; the data registering processor sending the received identifier and the received datum for data registering to the data processing device identified by the child data processing device address in the record with the received identifier or an hierarchically upper identifier than the received identifier, in case the received identifier is not the identifier of any of the records stored in the identifier-related data memory; the data retrieving processor sending the received identifier for data retrieving to the data processing device identified by the child data processing device address in the record with the received identifier or an hierarchically upper identifier than the received identifier, in case the received identifier is not the identifier of any of the records stored in the identifier-related data memory; the data retrieving processor retrieving a group of data as response from the data processing device to which the received identifier is sent.

### Mode 4:

The data processing device according to mode 3, wherein the identifier-related data memory is capable of storing a set of incremental data and a set of incremental descendant data; the set of incremental data being a set of data whose correlation with the identifier has not been reflected in upper order data processing devices; the set of incremental descendant data being a union of sets of descendant data related with each of all hierarchically lower identifiers than the identifier; the data registering processor adding received datum, in case the received identifier is the identifier of any of the records stored in the identifier-related data memory, not into a set of data of the record, but into the incremental data set of the record; the data processing device further comprising: a data update processor that updates, in case of retrieving the record by the identifier, the data set and the descendant data set with the incremental data of the record where the identifier is the received identifier.

### Mode 5:

The data processing device according to mode 3 or 4, further comprising: a child data processing device access necessity/non-necessity storage memory that stores necessity/non-necessity of access to the identifier or the data processing device lower in hierarchy than a predetermined order; the data registering processor adding data into a record of the data processing device into which it has been determined to be necessary to add datum based on the received identifier and on the stored contents of the child data processing device access necessity/non-necessity storage memory; the data registering processor registering in the child data processing device access necessity/non-necessity storage memory the identifier or the data processing device for which it has been determined to be unnecessary to add data based on the received identifier and on the stored contents of the child data processing device access necessity/non-necessity storage memory.

### Mode 6:

A data processing system in which a plurality of data processing devices according to any one of modes 3 to 5 are arranged hierarchically; wherein data registering processing is carried out on an upper most one of the hierarchically arranged data processing devices to execute data registering processing on a specified group of the data processing devices determined based on the received identifier; and wherein data retrieving processing is carried out on the upper most one of the hierarchically arranged data processing devices to execute data retrieving processing on the specified group of the data processing devices determined based on the received identifier.

### Mode 7:

A data processing control device connected to a directory server and to a plurality of the data processing devices according to mode 2, the data processing control device including: at least a data registering processor, the data registering processor reiterating, until data update ceases in data registering processing, the processing of changing a target identifier towards the parent side, with the received identifier as a starting point; and the processing of finding an address of the data processing device related with the target identifier from the directory server to perform data registering processing on the data processing device thus found.

### Mode 8:

A data processing system comprising a directory server, the data processing device according to mode 2 and the data processing control device according to mode 7.

### Mode 9:

Refer to the data processing method of the second aspect.

### Mode 10:

The data processing method according to mode 9, wherein the data processing devices are arrayed hierarchically; and when upper-order data processing devices do not hold a record having the received identifier, data registering processing or data retrieval processing for lower order data processing devices is invoked.

### Mode 11:

The data processing method according to mode 9 or 10, wherein, at a time point of receipt of a record update request by inputting of the identifier and data, the identifier and the data are stored as incremental data of the data processing device associated with the received identifier; the data set and the descendant data set being updated with the incremental data in retrieving the record by the identifier.

### Mode 12:

The data processing method according to any one of mode 9 to 11, wherein data registering processing for data processing devices lower in hierarchical order than a pre-specified data processing device is suppressed.

1. A data processing device comprising:
an identifier-related data memory that stores a plurality of records each of which contains a hierarchically-organized identifier, a set of data each of which is related with said identifier, and a set of descendant data, which set is a union of sets of data related with each of all hierarchically-lower identifiers than said identifier; and
a data registering processor;
said data registering processor receiving said identifier and said datum;
said data registering processor adding said received datum to the set of data of the record with the received identifier if the received identifier is the identifier of any of said records stored in said identifier-related data memory;
said data registering processor, otherwise, adding said received datum to the set of descendant data of the record with the hierarchically-upper identifier than said received identifier.

2. The data processing device according to claim 1, further comprising:
a data retrieving processor that retrieves the set of data in the record, the identifier of which is said received identifier, stored in said identifier-related data memory.

3. The data processing device according to claim 2, further comprising:
a child data processor memory that stores a plurality of records, each including an identifier and a child data processing device address which is an address of a data processing device hierarchically one level lower than said data processing device;
said data registering processor sending said received identifier and said received datum for data registering to the data processing device identified by the child data processing device address in the record with said received identifier or an hierarchically upper identifier than said received identifier, in case the received identifier is not the identifier of any of said records stored in said identifier-related data memory;
said data retrieving processor sending said received identifier for data retrieving to the data processing device identified by the child data processing device address in the record with said received identifier or an hierarchically upper identifier than said received identifier, in case said received identifier is not the identifier of any of said records stored in said identifier-related data memory;
said data retrieving processor retrieving a group of data as response from the data processing device to which said received identifier is sent.

4. The data processing device according to claim 3, wherein
said identifier-related data memory is capable of storing a set of incremental data and a set of incremental descendant data;
said set of incremental data being a set of data whose correlation with said identifier has not been reflected in upper order data processing devices; said set of incremental descendant data being a union of sets of descendant data related with each of all hierarchically lower identifiers than said identifier;
said data registering processor adding received datum, in case the received identifier is the identifier of any of the records stored in said identifier-related data memory, not into a set of data of said record, but into the incremental data set of said record;
the data processing device further comprising:
a data update processor that updates, in case of retrieving said record by said identifier, said data set and said descendant data set with the incremental data of the record where the identifier equals to said received identifier.

5. The data processing device according to claim 3, further comprising:
a child data processing device access necessity/non-necessity storage memory that stores necessity/non-necessity of access to the identifier or the data processing device lower in hierarchy than a predetermined order;
said data registering processor adding data into a record of the data processing device into which it has been determined to be necessary to add datum based on the received identifier and on the stored contents of said child data processing device access necessity/non-necessity storage memory;
said data registering processor registering in said child data processing device access necessity/non-necessity storage memory the identifier or the data processing device for which it has been determined to be unnecessary to add data based on the received identifier and on the stored contents of said child data processing device access necessity/non-necessity storage memory.

6. A data processing system in which a plurality of data processing devices according to claim 3 are arranged hierarchically; wherein
data registering processing is carried out on an upper most one of the hierarchically arranged data processing devices to execute data registering processing on a specified group of said data processing devices determined based on the received identifier; and wherein
data retrieving processing is carried out on the upper most one of the hierarchically arranged data processing devices to execute data retrieving processing on the specified group of said data processing devices determined based on the received identifier.

7. A data processing control device connected to a directory server and to a plurality of the data processing devices according to claim 2, said data processing control device including:
at least a data registering processor, said data registering processor reiterating, until data update ceases in data registering processing, the processing of changing a target identifier towards the parent side, with the received identifier as a starting point; and
the processing of finding an address of the data processing device related with said target identifier from said directory server to perform data registering processing on the data processing device thus found.

8. A data processing system comprising a directory server, the data processing device according to claim 2 and the data processing control device including:
at least a data registering processor, said data registering processor reiterating, until data update ceases in data registering processing, the processing of changing a target identifier towards the parent side, with the received identifier as a starting point; and
the processing of finding an address of the data processing device related with said target identifier from said directory server to perform data registering processing on the data processing device thus found.

9. A data processing method in which each of a plurality of data processing devices holds a plurality of records each of which contains a hierarchically-organized identifier, a set of data each of which is related with said identifier, and a set of descendant data that is a union of sets of data related with each of all hierarchically-lower identifiers than said identifier; wherein
each data processing device related with said identifier in accordance with a predetermined rule adds received datum to a set of data of the record with the received identifier;
the data processing device adding, in case the received identifier does not match to the identifier of any of the records stored, the received datum to a set of descendant data of the record with the hierarchically-upper identifier than said received identifier;
whereby each data processing device related with said identifier updates said record;
on receipt of data inquiry by said identifier, the data processing device related with said received identifier outputting data of the record having an identifier matches to said received identifier.

10. The data processing method according to claim 9, wherein
said data processing devices are arrayed hierarchically; and
when upper-order data processing devices do not hold a record having the received identifier, data registering processing or data retrieval processing for lower order data processing devices is invoked.

11. The data processing method according to claim 9, wherein, at a time point of receipt of a record update request by inputting of said identifier and data, said identifier and the data are stored as incremental data of the data processing device associated with the received identifier;
said data set and said descendant data set being updated with said incremental data in retrieving said record by said identifier.

12. The data processing method according to claim 9, wherein
data registering processing for data processing devices lower in hierarchical order than a pre-specified data processing device is suppressed.

13. The data processing device according to claim 4, further comprising:
a child data processing device access necessity/non-necessity storage memory that stores necessity/non-necessity of access to the identifier or the data processing device lower in hierarchy than a predetermined order;
said data registering processor adding data into a record of the data processing device into which it has been determined to be necessary to add datum based on the received identifier and on the stored contents of said child data processing device access necessity/non-necessity storage memory;
said data registering processor registering in said child data processing device access necessity/non-necessity storage memory the identifier or the data processing device for which it has been determined to be unnecessary to add data based on the received identifier and on the stored contents of said child data processing device access necessity/non-necessity storage memory.

14. A data processing system in which a plurality of data processing devices according to claim 4 are arranged hierarchically; wherein
data registering processing is carried out on an upper most one of the hierarchically arranged data processing devices to execute data registering processing on a specified group of said data processing devices determined based on the received identifier; and wherein
data retrieving processing is carried out on the upper most one of the hierarchically arranged data processing devices to execute data retrieving processing on the specified group of said data processing devices determined based on the received identifier.

15. A data processing system in which a plurality of data processing devices according to claim 5 are arranged hierarchically; wherein
data registering processing is carried out on an upper most one of the hierarchically arranged data processing devices to execute data registering processing on a specified group of said data processing devices determined based on the received identifier; and wherein
data retrieving processing is carried out on the upper most one of the hierarchically arranged data processing devices to execute data retrieving processing on the specified group of said data processing devices determined based on the received identifier.

16. The data processing method according to claim 10, wherein, at a time point of receipt of a record update request by inputting of said identifier and data, said identifier and the data are stored as incremental data of the data processing device associated with the received identifier;
said data set and said descendant data set being updated with said incremental data in retrieving said record by said identifier.

17. The data processing method according to claim 10, wherein
data registering processing for data processing devices lower in hierarchical order than a pre-specified data processing device is suppressed.

18. The data processing method according to claim 11, wherein data registering processing for data processing devices lower in hierarchical order than a pre-specified data processing device is suppressed.
